(19) United States
(12) Patent Application Publication
(10) Pub. No.: US 2026/0162910 A1
(43) Pub. Date: Jun. 11, 2026

(54) FABRIC SUPERCAPACITORS AND METHODS OF MAKING AND USE THEREOF

(71) Applicant: BOARD OF REGENTS, THE UNIVERSITY OF TEXAS SYSTEM, Austin, TX (US)

(72) Inventors: Jonathan CHEN, Austin, TX (US); Dong Seok LEE, Austin, TX (US)

(21) Appl. No.: 19/124,074

(22) PCT Filed: Oct. 24, 2023
(86) PCT No.: PCT/US2023/077590

§ 371 Date: Apr. 24, 2025

Related U.S. Application Data
(60) Provisional application No. 63/419,035, filed on Oct. 25, 2022.

(51) Int. Cl. H01G 11/26; B32B 5/02; B32B 5/26; H01G 11/52; H01G 11/68; H01G 11/86

(52) U.S. Cl. CPC H01G 11/26; B32B 5/022; B32B 5/267; H01G 11/52; H01G 11/68; H01G 11/86; B32B 2250/03; B32B 2457/16

(57) ABSTRACT

Disclosed herein are fabric devices, such as fabric supercapacitors, and methods of making and use thereof. For example, disclosed herein are fabric supercapacitors comprising: a first current collector layer comprising a first carbon fiber fabric; a first electrode layer comprising a first fabric; an ion permeable separator layer comprising a third fabric; a second electrode layer comprising a second fabric; and a second current collector layer comprising a second carbon fiber fabric. In some examples, the first fabric comprises a first plurality of fibers comprising a first polymer, a first electrolyte, and a first plurality of activated carbon granules. In some examples, the second fabric comprises a second plurality of fibers comprising a second polymer, a second electrolyte, and a second plurality of activated carbon granules. In some examples, the third fabric comprises a third electrolyte and a third plurality of fibers comprising a third polymer.

### CROSS-REFERENCE TO RELATED APPLICATIONS

This application claims the benefit of priority to U.S. Provisional Application No. 63/419,035 filed Oct. 25, 2022, which is hereby incorporated herein by reference in its entirety.

### STATEMENT OF GOVERNMENT SUPPORT

This invention was made with government support under Grant No. 2113334 awarded by the National Science Foundation. The government has certain rights in the invention.

### BACKGROUND

The development of improved energy storage devices is one of the keys for successful global energy management. However, one challenge is the improvement of transportable energy in applications such as wearable energy. Many research efforts focus on either directly overlaying conventional batteries onto existing textiles or coating energy storage materials on fabrics. Such approaches face tremendous difficulties in connections, bulkiness, wearability, and safety. An emerging tactic is to directly incorporate energy storage materials, as supercapacitors, at the formation stages of textile fibers. Supercapacitors, like batteries, can store energy and be used as a power source. While batteries store and release charge through chemical reactions, supercapacitors store it on the surface of their electrodes. Thus, supercapacitors can charge in minutes instead of hours and can recharge millions of times.

Multiple textile fibers can be spun into energy storage yarns which can be further fabricated into energy storage fabrics. Fiber supercapacitors, however, have limited dimensions and these devices can present challenges during the weaving process. There have been some studies on fabric electrode supercapacitors. However, these supercapacitors exhibited some practical limitations such as being relatively thick, which affects their flexibility. There is still a need for more lightweight, compact, and mechanically flexible energy storage devices. The compositions, devices, methods, and systems discussed herein address these and other needs.

### SUMMARY

In accordance with the purposes of the disclosed compositions, devices, methods, and systems as embodied and broadly described herein, the disclosed subject matter relates to fabric devices, such as fabric supercapacitors, and methods of making and use thereof.

For example, disclosed herein are fabric supercapacitors comprising: an ion permeable separator layer; a first electrode layer; a second electrode layer; a first current collector layer; and a second current collector layer. In some examples, the ion permeable separator layer is disposed between (e.g., sandwiched between) the first electrode layer and the second electrode layer, such that the ion permeable separator layer is in physical and electrical contact with the first electrode layer and the second electrode layer. In some examples, the first electrode layer is disposed between (e.g., sandwiched between) the first current collector layer and the ion permeable separator layer, such that the first electrode layer is in physical and electrical contact with both the first current collector layer and the ion permeable separator layer. In some examples, the second electrode layer is disposed between (e.g., sandwiched between) the ion permeable separator layer and the second current collector layer, such that the second electrode layer is in physical and electrical contact with both the ion permeable separator layer and the second current collector layer. In some examples, the first electrode layer comprises a first fabric comprising a first plurality of fibers, the first plurality of fibers comprising a first polymer, and the first fabric further comprising a first electrolyte and a first plurality of activated carbon granules disposed therein. In some examples, the second electrode layer comprises a second fabric comprises a second plurality of fibers, the second plurality of fibers comprising a second polymer, the second fabric further comprising a second electrolyte and a second plurality of activated carbon granules disposed therein. In some examples, the ion permeable separator layer comprising a third fabric comprising a third plurality of fibers, the third plurality of fibers comprising a third polymer, the third fabric further comprising a third electrolyte disposed therein. In some examples, the first current collector layer comprising a first carbon fiber fabric. In some examples, the second current collector layer comprising a second carbon fiber fabric.

In some examples, the first fabric, the second fabric, the third fabric, or a combination thereof is a nonwoven fabric.

In some examples, the first fabric, the second fabric, the third fabric, or a combination thereof further comprises a mesh substrate, the plurality of fibers being disposed on the mesh substrate. In some examples, the mesh substrate comprises a fabric mesh substrate, such as a woven mesh substrate.

In some examples, the first polymer, the second polymer, the third polymer, or a combination thereof independently comprises a polyamide, a polyolefin, a polyester, a cellulose, a starch, a polyacrylonitrile, a vinyl polymer, or a combination thereof. In some examples, the first polymer, the second polymer, the third polymer, or a combination thereof independently comprises a polyvinyl alcohol, polyvinyl acetate, starch, or combinations thereof. In some examples, the first polymer, the second polymer, and the third polymer each independently comprises a polyvinyl alcohol.

In some examples, the first plurality of fibers, the second plurality of fibers, the third plurality of fibers, or a combination thereof independently have an average diameter of from 1 nanometer to 1 micrometer.

In some examples, the first electrolyte, the second electrolyte, the third electrolyte, or a combination thereof independently comprises a metal salt such as a metal hydroxide, phosphoric acid, sulfuric acid, or a combination thereof. In some examples, the first electrolyte, the second electrolyte, the third electrolyte, or a combination thereof independently comprises a lithium salt, potassium hydroxide, phosphoric acid, sulfuric acid, or a combination thereof. In some examples, first electrolyte, the second electrolyte, the third electrolyte, or a combination thereof independently comprises H₃PO₄.

In some examples, the first fabric, the second fabric, the third fabric, or a combination thereof independently has an average thickness of 5 μm to 1500 μm.

In some examples, the first fabric and/or the second fabric has an area density of from 10 to 200 g/m².

In some examples, the first fabric and/or the second fabric has a tensile strength (warp/machine direction) of from 1 to 50 MPa.

In some examples, the first fabric and/or the second fabric has a tear strength (warp/machine direction) of from 1 to 25 N.

In some examples, the first fabric comprises the first plurality of activated carbon granules in an amount of from 7.5% to 95% by weight, based on the total weight of the first fabric.

In some examples, the second fabric comprises the second plurality of activated carbon granules in an amount of from 7.5% to 95% by weight, based on the total weight of the second fabric.

In some examples, the first fabric further comprises a first plurality of conductive particles disposed therein, the second fabric further comprises a second plurality of conductive particles disposed therein, or a combination thereof. In some examples, the first plurality of conductive particles comprise a first metal and/or a first metal oxide, the second plurality of conductive particles comprise a second metal and/or a second metal oxide, or a combination thereof. In some examples, the first plurality of conductive particles and the second plurality of conductive particles are the same.

In some examples, the first fabric and the second fabric are the same.

In some examples, the first electrode layer and the second electrode layer are the same.

In some examples, the third fabric has an area density of from 10 to 100 g/m².

In some examples, the third fabric has a tensile strength (warp/machine direction) of from 1 MPa to 50 MPa.

In some examples, the third fabric has a tear strength (warp/machine direction) of from 1 to 25 N.

In some examples, the ion permeable separator layer comprises a plurality of layers of the third fabric.

In some examples, the first carbon fiber fabric and/or the second carbon fiber fabric is a woven, knitted, or non-woven fabric.

In some examples, the first carbon fiber fabric and/or the second carbon fiber fabric has a carbon content of at least 95% by weight of the fabric.

In some examples, the first carbon fiber fabric and/or the second carbon fiber fabric has a basis weight of from 100 g/m² to 250 g/m².

In some examples, the first carbon fiber fabric and/or the second carbon fiber fabric has an average thickness of 100 μm to 1000 μm.

In some examples, the first carbon fiber fabric and the second carbon fiber fabric are the same.

In some examples, the first current collector layer and the second current collector layer are the same.

In some examples, the fabric supercapacitor has a specific capacitance of 4 mF/cm² or more at a scan rate of 10 mV/s.

In some examples, the fabric supercapacitor has an energy density of 5×10⁻⁴ Wh/cm² or more at a scan rate of 10 mV/s.

In some examples, the fabric supercapacitor has a power density of 19 W/cm² or more at a scan rate of 10 mV/s.

In some examples, the fabric supercapacitor has an average total thickness of from 215 μm to 6500 μm.

In some examples, the fabric supercapacitor has a total basis weight of from 250 to 1000 g/m².

In some examples, the layers of the fabric supercapacitor are held together via compressive force.

In some examples, the layers of the fabric supercapacitor are sewn together.

In some examples, the fabric supercapacitor is flexible.

In some examples, the fabric supercapacitor is substantially free of electrolyte liquids, electrolyte gels, polymer gels, adhesives, or a combination thereof.

Also disclosed herein are articles comprising any of the fabric supercapacitors disclosed herein. In some examples, the article is a garment, a housing (such as a tent), an umbrella, or a bag (such as a backpack).

Also disclosed herein are methods of producing any of the fabric supercapacitors disclosed herein. In some examples, the methods comprise disposing the first electrode layer on the first current collector layer. In some examples, the methods further comprise disposing the ion permeable separator layer on the first electrode layer. In some examples, the methods further comprise disposing the second electrode layer the ion permeable separator layer. In some examples, the methods further comprise disposing the second current collector layer on the second electrode layer.

In some examples, the method further comprises making the first electrode layer, the second electrode layer, the ion permeable separator layer, or a combination thereof.

In some examples, the method further comprises making the first electrode layer by making the first fabric, the method comprising: spinning a first mixture of the first polymer and the first electrolyte to form a first precursor fabric, and depositing the first plurality of activated carbon granules on the first precursor fabric.

In some examples, the method further comprises making the second electrode layer by making the second fabric, the method comprising: spinning a second mixture of the second polymer and the second electrolyte to form a second precursor fabric, and depositing the second plurality of activated carbon granules on the second precursor fabric.

In some examples, the method further comprises making the ion permeable separator layer by making the third fabric, the method comprising: spinning a third mixture of the third polymer and the third electrolyte.

In some examples, the first mixture further comprises a first solvent, the second mixture further comprises a second solvent, the third mixture further comprises a third solvent, or a combination thereof.

In some examples, the methods further comprise making the first mixture, the second mixture, the third mixture, or a combination thereof.

In some examples, wherein the first plurality of activated carbon granules are dispersed in a fourth solvent and/or the second plurality of activated carbon granules are dispersed in a fifth solvent.

In some examples, spinning the first mixture, the second mixture, the third mixture, or a combination thereof independently comprises centrifugal spinning.

In some examples, the methods further comprise agitating the first mixture, the second mixture, the third mixture, or a combination thereof before spinning.

In some examples, the methods further comprise sewing the layers together.

Additional advantages of the disclosed compositions, devices, systems, and methods will be set forth in part in the description which follows, and in part will be obvious from the description. The advantages of the disclosed compositions, devices, systems, and methods will be realized and attained by means of the elements and combinations particularly pointed out in the appended claims. It is to be understood that both the foregoing general description and the following detailed description are exemplary and explanatory only and are not restrictive of the disclosed compositions, devices, systems, and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1. Photograph of an example Nano-FSC unit.

FIG. 2. An schematic illustration of an example NANO-FSC multiple layer structure.

FIG. 3. Photograph of electrode fabric.

FIG. 4. SEM image of electrode fabric (PVA/H₃PO₄ nanofiber web encapsulating ACG).

FIG. 5. Photograph of separator fabric.

FIG. 6. SEM image of separator fabric (PVA/H₃PO₄ nanofiber web).

FIG. 7. NANO-FSC CV curve.

FIG. 8. NANO-FSC GCD curve.

FIG. 9. NANO-FSC EIS plot.

FIG. 10. NANO-FSC device charge/discharge behavior by solar cell.

FIG. 11. Photograph of centrifugal force spinning equipment.

FIG. 12. A schematic illustration of an example device as disclosed herein according to an example implementation.

FIG. 13. A schematic illustration of an example device as disclosed herein according to an example implementation.

FIG. 14. Lab-scale press.

FIG. 15. Pressed FSC sample (E2A1Z10).

FIG. 16. CV diagram of FSC sample without pressing.

FIG. 17. CV diagram of FSC sample with pressing at 3 bars for 500 seconds.

FIG. 18. CV diagram of FSC sample with pressing at 2 bars for 10 seconds.

FIG. 19. Nyquist plot of FSC sample without pressing.

FIG. 20. Nyquist plot of FSC sample with pressing at 3 bars for 500 seconds.

FIG. 21. Nyquist plot of FSC sample with pressing at 2 bars for 10 seconds.

FIG. 22. GCD of FSC sample with pressing at 3 bars for 500 seconds.

FIG. 23. GCD plot of FSC sample with pressing at 2 bars for 10 seconds.

FIG. 24. Electric circuit used for Nyquist plot fitting.

FIG. 25. Nyquist curve fitting of the three electrolyte layers in the high frequency range.

FIG. 26. Nyquist plot for comparison of different electrolyte layers.

FIG. 27. Nyquist plot for various number of electrolyte layers (high frequency region).

### DETAILED DESCRIPTION

The compositions, devices, methods, and systems described herein may be understood more readily by reference to the following detailed description of specific aspects of the disclosed subject matter and the Examples included therein.

Before the present compositions, devices, methods, and systems are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Exemplary” means “an example of” and is not intended to convey an indication of a preferred or ideal embodiment. “Such as” is not used in a restrictive sense, but for explanatory purposes.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

“Polymer” means a material formed by polymerizing one or more monomers.

The term “(co) polymer” includes homopolymers, copolymers, or mixtures thereof.

The term “(meth)acryl . . . ” includes “acryl . . . ,” “methacryl . . . ,” or mixtures thereof.

Unless stated to the contrary, a formula with chemical bonds shown only as solid lines and not as wedges or dashed lines contemplates each possible stereoisomer or mixture of stereoisomer (e.g., each enantiomer, each diastereomer, each meso compound, a racemic mixture, or scalemic mixture).

### Fabric Supercapacitors

Disclosed herein are fabric supercapacitors and methods of making and use thereof.

For example, disclosed herein are fabric supercapacitors. For example, referring now to FIG. 12, disclosed herein are fabric supercapacitors 100 comprising: an ion permeable separator layer 110; a first electrode layer 120; a second electrode layer 122; a first current collector layer 130; and a second current collector layer 132; wherein: the ion permeable separator layer 110 is disposed between (e.g., sandwiched between) the first electrode layer 120 and the second electrode layer 122, such that the ion permeable separator layer 110 is in physical and electrical contact with the first electrode layer 120 and the second electrode layer 122; the first electrode layer 120 is disposed between (e.g., sandwiched between) the first current collector layer 130 and the ion permeable separator layer 110, such that the first electrode layer 120 is in physical and electrical contact with both the first current collector layer 130 and the ion permeable separator layer 110; and the second electrode layer 122 is disposed between (e.g., sandwiched between) the ion permeable separator layer 110 and the second current collector layer 132, such that the second electrode layer 122 is in physical and electrical contact with both the ion permeable separator layer 110 and the second current collector layer 132.

The first electrode layer 120 comprises a first fabric comprising a first plurality of fibers, the first plurality of fibers comprising a first polymer, and the first fabric further comprising a first electrolyte and a first plurality of activated carbon granules disposed therein. The second electrode layer 122 comprises a second fabric comprises a second plurality of fibers, the second plurality of fibers comprising a second polymer, the second fabric further comprising a second electrolyte and a second plurality of activated carbon granules disposed therein. The ion permeable separator layer 110 comprising a third fabric comprising a third plurality of fibers, the third plurality of fibers comprising a third polymer, the third fabric further comprising a third electrolyte disposed therein. The first current collector layer 130 comprising a first carbon fiber fabric. The second current collector layer 132 comprising a second carbon fiber fabric.

In some examples, the first fabric, the second fabric, the third fabric, or a combination thereof is a nonwoven fabric.

In some examples, the first fabric, the second fabric, the third fabric, or a combination thereof further comprises a mesh substrate, the plurality of fibers being disposed on the mesh substrate. In some examples, the mesh substrate comprises a fabric mesh substrate, such as a woven mesh substrate.

In some examples, the first polymer, the second polymer, the third polymer, or a combination thereof independently comprises a polyamide, a polyolefin, a polyester, a cellulose, a starch, a polyacrylonitrile, a vinyl polymer, or a combination thereof. In some examples, the first polymer, the second polymer, the third polymer, or a combination thereof independently comprises a polyvinyl alcohol, polyvinyl acetate, starch, or combinations thereof. In some examples, the first polymer, the second polymer, and the third polymer each independently comprises a polyvinyl alcohol.

In some examples, the first plurality of fibers, the second plurality of fibers, the third plurality of fibers, or a combination thereof independently have an average diameter of 1 nanometer (nm) or more (e.g., 2 nm or more, 3 nm or more, 4 nm or more, 5 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 300 nm or more, 350 nm or more, 400 nm or more, 450 nm or more, 500 nm or more, 550 nm or more, 600 nm or more, 650 nm or more, 700 nm or more, 750 nm or more, 800 nm or more, 850 nm or more, 900 nm or more, or 950 nm or more). In some examples, the first plurality of fibers, the second plurality of fibers, the third plurality of fibers, or a combination thereof independently have an average diameter of 1 micrometer (micron, μm) or less (e.g., 950 nm or less, 900 nm or less, 850 nm or less, 800 nm or less, 750 nm or less, 700 nm or less, 650 nm or less, 600 nm or less, 550 nm or less, 500 nm or less, 450 nm or less, 400 nm or less, 350 nm or less, 300 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, nm or less, 20 nm or less, 15 nm or less, 10 nm or less, 5 nm or less, 4 nm or less, 3 nm or less, or 2 nm or less). The average diameter of the first plurality of fibers, the second plurality of fibers, the third plurality of fibers, or a combination thereof can independently range from any of the minimum values described above to any of the maximum values described above. For example, the first plurality of fibers, the second plurality of fibers, the third plurality of fibers, or a combination thereof independently have an average diameter of from 1 nanometer to 1 micrometer (e.g., from 1 nm to 500 nm, from 500 nm to 1000 nm, from 1 nm to 200 nm, from 200 nm to 400 nm, from 400 nm to 600 nm, from 600 nm to 800 nm, from 800 nm to 1000 nm, from 1 nm to 800 nm, from 1 nm to 600 nm, from 1 nm to 400 nm, from 1 nm to 100 nm, from 1 nm to 50 nm, from 1 nm to 25 nm, from 1 nm to 10 nm, from 5 nm to 1000 nm, from 10 nm to 1000 nm, from 25 nm to 1000 nm, from 50 nm to 1000 nm, from 100 nm to 1000 nm, from 200 nm to 1000 nm, from 400 nm to 1000 nm, from 600 nm to 1000 nm, from 5 nm to 950 nm, from nm to 900 nm, or from 50 nm to 800 nm).

In some examples, the first electrolyte, the second electrolyte, the third electrolyte, or a combination thereof independently comprises a metal salt such as a metal hydroxide, phosphoric acid, sulfuric acid, or a combination thereof. In some examples, the first electrolyte, the second electrolyte, the third electrolyte, or a combination thereof independently comprises a lithium salt, potassium hydroxide, phosphoric acid, sulfuric acid, or a combination thereof. In some examples, the first electrolyte, the second electrolyte, the third electrolyte, or a combination thereof independently comprises H₃PO₄.

In some examples, the first fabric, the second fabric, the third fabric, or a combination thereof independently has an average thickness of 5 μm or more (e.g., 10 μm or more, 15 μm or more, 20 μm or more, 25 μm or more, 30 μm or more, 35 μm or more, 40 μm or more, 45 μm or more, 50 μm or more, 60 μm or more, 70 μm or more, 80 μm or more, 90 μm or more, 100 μm or more, 125 μm or more, 150 μm or more, 175 μm or more, 200 μm or more, 225 μm or more, 250 μm or more, 300 μm or more, 350 μm or more, 400 μm or more, 450 μm or more, 500 μm or more, 550 μm or more, 600 μm or more, 650 μm or more, 700 μm or more, 750 μm or more, 800 μm or more, 850 μm or more, 900 μm or more, 950 μm or more, 1000 μm or more, 1100 μm or more, 1200 μm or more, 1300 μm or more, or 1400 μm or more). In some examples, the first fabric, the second fabric, the third fabric, or a combination thereof independently has an average thickness of 1500 μm or less (e.g., 1400 μm or less, 1300 μm or less, 1200 μm or less, 1100 μm or less, 1000 μm or less, 950 μm or less, 900 μm or less, 850 μm or less, 800 μm or less, 750 μm or less, 700 μm or less, 650 μm or less, 600 μm or less, 550 μm or less, 500 μm or less, 450 μm or less, 400 μm or less, 350 μm or less, 300 μm or less, 250 μm or less, 225 μm or less, 200 μm or less, 175 μm or less, 150 μm or less, 125 μm or less, 100 μm or less, 90 μm or less, 80 μm or less, 70 μm or less, 60 μm or less, 50 μm or less, 45 μm or less, 40 μm or less, 35 μm or less, 30 μm or less, 25 μm or less, 20 μm or less, 15 μm or less, or 10 μm or less). The average thickness of the first fabric, the second fabric, the third fabric, or a combination thereof can independently range from any of the minimum values described above to any of the maximum values described above. For example, the first fabric, the second fabric, the third fabric, or a combination thereof independently can have an average thickness of from 5 μm to 1500 μm (e.g., from 5 μm to 750 μm, from 750 μm to 1500 μm, from 5 μm to 500 μm, from 500 μm to 1000 μm, from 1000 μm to 1500 μm, from 10 μm to 1500 μm, from 25 μm to 1500 μm, from 50 μm to 1500 μm, from 100 μm to 1500 μm, from 250 μm to 1500 μm, from 500 μm to 1500 μm, from 1250 μm to 1500 μm, from 5 μm to 1250 μm, from 5 μm to 1000 μm, from 5 μm to 750 μm, from 5 μm to 250 μm, from 5 μm to 100 μm, from 5 μm to 50 μm, from 5 μm to μm 25, from 10 μm to 1400 μm, from 20 μm to 1200 μm, or from 50 μm to 1000 μm).

In some examples, the first fabric and/or the second fabric has an area density of 20 g/m² or more (e.g., 25 g/m² or more, 30 g/m² or more, 35 g/m² or more, 40 g/m² or more, 45 g/m² or more, 50 g/m² or more, 60 g/m² or more, 70 g/m² or more, 80 g/m² or more, 90 g/m² or more, 100 g/m² or more, 110 g/m² or more, 120 g/m² or more, 130 g/m² or more, 140 g/m² or more, 150 g/m² or more, 160 g/m² or more, 170 g/m² or more, 180 g/m² or more, or 190 g/m² or more). In some examples, the first fabric and/or the second fabric has an area density of 200 g/m² or less (e.g., 190 g/m² or less, 180 g/m² or less, 170 g/m² or less, 160 g/m² or less, 150 g/m² or less, 140 g/m² or less, 130 g/m² or less, 120 g/m² or less, 110 g/m² or less, 100 g/m² or less, 90 g/m² or less, 80 g/m² or less, 70 g/m² or less, 60 g/m² or less, 50 g/m² or less, 45 g/m² or less, 40 g/m² or less, 35 g/m² or less, 30 g/m² or less, or 25 g/m² or less). The area density of the first fabric and/or the second fabric can independently range from any of the minimum values described above to any of the maximum values described above. For example, the first fabric and/or the second fabric can have an area density of from 20 to 200 g/m² (e.g., from 20 g/m² to 100 g/m², from 100 g/m² to 200 g/m², from 20 g/m² to 80 g/m², from 80 g/m² to 140 g/m², from 140 g/m² to 200 g/m², from 25 g/m² to 200 g/m², from 50 g/m² to 200 g/m², from 75 g/m² to 200 g/m², from 125 g/m² to 200 g/m², from 150 g/m² to 200 g/m², from 20 g/m² to 175 g/m², from 20 g/m² to 150 g/m², from 20 g/m² to 125 g/m², from 20 g/m² to 75 g/m², from 20 g/m² to 50 g/m², from 25 g/m² to 190 g/m², from 30 g/m² to 180 g/m², or from 50 g/m² to 150 g/m²).

In some examples, the first fabric and/or the second fabric has a tensile strength (warp/machine direction) of 1 MPa or more (e.g., 2 MPa or more, 3 MPa or more, 4 MPa or more, 5 MPa or more, 10 MPa or more, 15 MPa or more, 20 MPa or more, 25 MPa or more, 30 MPa or more, 35 MPa or more, 40 MPa or more, or 45 MPa or more). In some examples, the first fabric and/or the second fabric has a tensile strength (warp/machine direction) of 50 MPa or less (e.g., 45 MPa or less, 40 MPa or less, 35 MPa or less, 30 MPa or less, 25 MPa or less, 20 MPa or less, 15 MPa or less, 10 MPa or less, 5 MPa or less, 4 MPa or less, 3 MPa or less, or 2 MPa or less). The tensile strength (warp/machine direction) of the first fabric and/or the second fabric can independently range from any of the minimum values described above to any of the maximum values described above. For example, the first fabric and/or the second fabric can have a tensile strength (warp/machine direction) of from 1 to 50 MPa (e.g., from 1 MPa to 25 MPa, from 25 MPa to 50 MPa, from 1 MPa to 10 MPa, from 10 MPa to 20 MPa, from 20 MPa to 30 MPa, from 30 MPa to 40 MPa, from 40 MPa to 50 MPa, from 1 MPa to 40 MPa, from 1 MPa to 30 MPa, from 1 MPa to 20 MPa, from 1 MPa to 5 MPa, from 5 MPa to 50 MPa, from 10 MPa to 50 MPa, from 20 MPa to 50 MPa, from 30 MPa to 50 MPa, from 5 MPa to 45 MPa, or from 10 MPa to 40 MPa).

In some examples, the first fabric and/or the second fabric has a tear strength (warp/machine direction) of 1 N or more (e.g., 2 N or more, 3 N or more, 4 N or more, 5 N or more, 6 N or more, 7 N or more, 8 N or more, 9 N or more, 10 N or more, 11 N or more, 12 N or more, 13 N or more, 14 N or more, 15 N or more, 16 N or more, 17 N or more, 18 N or more, 19 N or more, 20 N or more, 21 N or more, 22 N or more, 23 N or more, or 24 N or more). In some examples, the first fabric and/or the second fabric has a tear strength (warp/machine direction) of N or less (e.g., 24 N or less, 23 N or less, 22 N or less, 21 N or less, 20 N or less, 19 N or less, 18 N or less, 17 N or less, 16 N or less, 15 N or less, 14 N or less, 13 N or less, 12 N or less, 11 N or less, 10 N or less, 9 N or less, 8 N or less, 7 N or less, 6 N or less, 5 N or less, 4 N or less, 3 N or less, or 2 N or less). The tear strength (warp/machine direction) of the first fabric and/or the second fabric can independently range from any of the minimum values described above to any of the maximum values described above. For example, the first fabric and/or the second fabric has a tear strength (warp/machine direction) of from 1 to 25 N (e.g., from 1 N to 12 N, from 12 N to 25 N, from 1 N to 5 N, from 5 N to 10 N, from 10 N to 15 N, from 15 N to 20 N, from 20 N to 25 N, from 5 N to 25 N, from 10 N to 25 N, from 15 N to 25 N, from 1 N to 20 N, from 1 N to N, from 1 N to 10 N, from 2 N to 24 N, from 3 N to 23 N, from 4 N to 22 N, or from 5 N to N).

In some examples, the first fabric comprises the first plurality of activated carbon granules in an amount of 7.5% or more by weight, based on the total weight of the first fabric (e.g., 8% or more, 8.5% or more, 9% or more, 9.5% or more, 10% or more, 11% or more, 12% or more, 13% or more, 14% or more, 15% or more, 20% or more, 25% or more, 30% or more, 35% or more, 40% or more, 45% or more, 50% or more, 60% or more, 70% or more, 80% or more, or 90% or more). In some examples, the first fabric comprises the first plurality of activated carbon granules in an amount of 95% by weight or less, based on the total weight of the first fabric (e.g., 90% or less, 80% or less, 70% or less, 60% or less, 50% or less, 45% or less, 40% or less, 35% or less, 30% or less, 25% or less, 20% or less, 15% or less, 14% or less, 13% or less, 12% or less, 11% or less, 10% or less, 9.5% or less, 9% or less, 8.5% or less, or 8% or less). The amount of the first plurality of activated carbon granules in the first fabric can range from any of the minimum values described above to any of the maximum values described above. For example, the first fabric can comprise the first plurality of activated carbon granules in an amount of from 7.5% to 95% by weight, based on the total weight of the first fabric (e.g., from 7.5% to 50%, from 50% to 95%, from 7.5% to 30%, from 30% to 60%, from 60% to 95%, from 7.5% to 90%, from 7.5% to 80%, from 7.5% to 70%, from 7.5% to 60%, from 7.5% to 50%, from 7.5% to 40%, from 7.5% to 20%, from 10% to 95%, from 20% to 95%, from 30% to 95%, from 40% to 95%, from 50% to 95%, from 70% to 95%, from 80% to 95%, from 10% to 90%, from 20% to 80%, or from 25% to 75%).

In some examples, the second fabric comprises the second plurality of activated carbon granules in an amount of 7.5% or more by weight, based on the total weight of the second fabric (e.g., 8% or more, 8.5% or more, 9% or more, 9.5% or more, 10% or more, 11% or more, 12% or more, 13% or more, 14% or more, 15% or more, 20% or more, 25% or more, 30% or more, 35% or more, 40% or more, 45% or more, 50% or more, 60% or more, 70% or more, 80% or more, or 90% or more). In some examples, the second fabric comprises the second plurality of activated carbon granules in an amount of 95% by weight or less, based on the total weight of the second fabric (e.g., 90% or less, 80% or less, 70% or less, 60% or less, 50% or less, 45% or less, 40% or less, 35% or less, 30% or less, 25% or less, 20% or less, 15% or less, 14% or less, 13% or less, 12% or less, 11% or less, 10% or less, 9.5% or less, 9% or less, 8.5% or less, or 8% or less). The amount of the second plurality of activated carbon granules in the second fabric can range from any of the minimum values described above to any of the maximum values described above. For example, the second fabric can comprise the second plurality of activated carbon granules in an amount of from 7.5% to 95% by weight, based on the total weight of the second fabric (e.g., from 7.5% to 50%, from 50% to 95%, from 7.5% to 30%, from 30% to 60%, from 60% to 95%, from 7.5% to 90%, from 7.5% to 80%, from 7.5% to 70%, from 7.5% to 60%, from 7.5% to 50%, from 7.5% to 40%, from 7.5% to 20%, from 10% to 95%, from 20% to 95%, from 30% to 95%, from 40% to 95%, from 50% to 95%, from 70% to 95%, from 80% to 95%, from 10% to 90%, from 20% to 80%, or from 25% to 75%).

In some examples, the first fabric further comprises a first plurality of conductive particles disposed therein, the second fabric further comprises a second plurality of conductive particles disposed therein, or a combination thereof. In some examples, the first plurality of conductive particles comprises a first metal, the second plurality of conductive particles comprise a second metal, or a combination thereof. In some examples, the first plurality of conductive particles comprises a first metal oxide, the second plurality of conductive particles comprise a second metal oxide, or a combination thereof. In some examples, the first plurality of conductive particles and the second plurality of conductive particles are the same. In some examples, the first plurality of conductive particles and the second plurality of conductive particles comprise ZnO.

The first plurality of conductive particles and/or the second plurality of conductive particles can independently have an average particle size. “Average particle size” and “mean particle size” are used interchangeably herein, and generally refer to the statistical mean particle size of the particles in a population of particles. For example, the average particle size for a plurality of particles with a substantially spherical shape can comprise the average diameter of the plurality of particles. As used herein, the size of a particle can refer to the largest linear distance between two points on the surface of the particle. For an anisotropic particle, the average particle size can refer to, for example, the average maximum dimension of the particle (e.g., the length of a rod-shaped particle, the diagonal of a cube shape particle, the bisector of a triangular shaped particle, etc.). Mean particle size can be measured using methods known in the art, such as evaluation by electron microscopy.

The first plurality of conductive particles and/or the second plurality of conductive particles can independently an average particle size of 5 nm or more (e.g., 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 300 nm or more, 350 nm or more, 400 nm or more, 450 nm or more, 500 nm or more, 550 nm or more, 600 nm or more, 650 nm or more, 700 nm or more, 750 nm or more, 800 nm or more, 850 nm or more, 900 nm or more, or 950 nm or more). In some examples, the first plurality of conductive particles and/or the second plurality of conductive particles can independently an average particle size of 1 micrometer (micron, μm) or less (e.g., 950 nm or less, 900 nm or less, 850 nm or less, 800 nm or less, 750 nm or less, 700 nm or less, 650 nm or less, 600 nm or less, 550 nm or less, 500 nm or less, 450 nm or less, 400 nm or less, 350 nm or less, 300 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, or 10 nm or less). The average particle size of the first plurality of conductive particles and/or the second plurality of conductive particles can independently range from any of the minimum values described above to any of the maximum values described above. For example, the first plurality of conductive particles and/or the second plurality of conductive particles can independently an average particle size of from 5 nm to 1000 nm (e.g., from 5 nm to 500 nm, from 500 nm to 1000 nm, from 5 nm to 200 nm, from 200 nm to 400 nm, from 400 nm to 600 nm, from 600 nm to 800 nm, from 800 nm to 1000 nm, from 5 nm to 800 nm, from 5 nm to 600 nm, from 5 nm to 400 nm, from 5 nm to 100 nm, from 5 nm to 50 nm, from 5 nm to 25 nm, from 10 nm to 1000 nm, from 25 nm to 1000 nm, from 50 nm to 1000 nm, from 100 nm to 1000 nm, from 200 nm to 1000 nm, from 400 nm to 1000 nm, from 600 nm to 1000 nm, from 10 nm to 950 nm, from 15 nm to 900 nm, or from 50 nm to 800 nm).

In some examples, the first plurality of conductive particles and/or the second plurality of conductive particles can be substantially monodisperse. “Monodisperse” and “homogeneous size distribution,” as used herein, and generally describe a population of particles where all of the particles have the same or nearly the same particle size. As used herein, a monodisperse distribution refers to distributions in which 80% of the distribution (e.g., 85% of the distribution, 90% of the distribution, or 95% of the distribution) lies within 25% of the mean particle size (e.g., within 20% of the mean particle size, within 15% of the mean particle size, within 10% of the mean particle size, or within 5% of the mean particle size).

The first plurality of conductive particles and/or the second plurality of conductive particles can, independently, be of any shape, such as a regular shape, an irregular shape, an isotropic shape, or an anisotropic shape (e.g., a sphere, a rod, a quadrilateral, an ellipse, a triangle, a polygon, etc.).

In some examples, the first fabric can include the first plurality of conductive particles in an amount of from 0.1% or more by weight based on the total weight of the first fabric (e.g., 0.25% or more, 0.5% or more, 0.75% or more, 1% or more, 2% or more, 3% or more, 4% or more, 5% or more, 10% or more, 15% or more, 20% or more, 25% or more, 30% or more, 35% or more, 40% or more, 45% or more, 50% or more, or 55% or more). In some examples, the first fabric can include the first plurality of conductive particles in an amount of from 60% or less by weight based on the total weight of the first fabric (e.g., 55% or less, 50% or less, 45% or less, 40% or less, 35% or less, 30% or less, 25% or less, 20% or less, 15% or less, 10% or less, 5% or less, 4% or less, 3% or less, 2% or less, 1% or less, 0.75% or less, 0.5% or less, or 0.25% or less). The amount of the first plurality of conductive particles in the first fabric can range from any of the minimum values described above to any of the maximum values described above. For example, the first fabric can include the first plurality of conductive particles in an amount of from 0.1% to 60% by weight based on the total weight of the first fabric (e.g., from 0.1% to 30%, from 30% to 60%, from 0.1% to 10%, from 10% to 20%, from 20% to 30%, from 30% to 40%, from 40% to 50%, from 50% to 60%, from 0.5% to 60%, from 1% to 60%, from 5% to 60%, from 10% to 60%, from 20% to 60%, from 40% to 60%, from 0.1% to 50%, from 0.1% to 40%, from 0.1% to 20%, from 0.1% to 10%, from 0.1% to 5%, from 0.5% to 55%, or from 1% to 50%).

In some examples, the second fabric can include the second plurality of conductive particles in an amount of from 0.1% or more by weight based on the total weight of the second fabric (e.g., 0.25% or more, 0.5% or more, 0.75% or more, 1% or more, 2% or more, 3% or more, 4% or more, 5% or more, 10% or more, 15% or more, 20% or more, 25% or more, 30% or more, 35% or more, 40% or more, 45% or more, 50% or more, or 55% or more). In some examples, the second fabric can include the second plurality of conductive particles in an amount of from 60% or less by weight based on the total weight of the second fabric (e.g., 55% or less, 50% or less, 45% or less, 40% or less, 35% or less, 30% or less, 25% or less, 20% or less, 15% or less, 10% or less, 5% or less, 4% or less, 3% or less, 2% or less, 1% or less, 0.75% or less, 0.5% or less, or 0.25% or less). The amount of the second plurality of conductive particles in the second fabric can range from any of the minimum values described above to any of the maximum values described above. For example, the second fabric can include the second plurality of conductive particles in an amount of from 0.1% to 60% by weight based on the total weight of the second fabric (e.g., from 0.1% to 30%, from 30% to 60%, from 0.1% to 10%, from 10% to 20%, from 20% to 30%, from 30% to 40%, from 40% to 50%, from 50% to 60%, from 0.5% to 60%, from 1% to 60%, from 5% to 60%, from 10% to 60%, from 20% to 60%, from 40% to 60%, from 0.1% to 50%, from 0.1% to 40%, from 0.1% to 20%, from 0.1% to 10%, from 0.1% to 5%, from 0.5% to 55%, or from 1% to 50%).

In some examples, the first fabric and the second fabric are the same.

In some examples, the first electrode layer 120 and the second electrode layer 122 are the same.

In some examples, the third fabric has an area density of 10 g/m² or more (e.g., 15 g/m² or more, 20 g/m² or more, 25 g/m² or more, 30 g/m² or more, 35 g/m² or more, 40 g/m² or more, 45 g/m² or more, 50 g/m² or more, 55 g/m² or more, 60 g/m² or more, 65 g/m² or more, 70 g/m² or more, 75 g/m² or more, 80 g/m² or more, 85 g/m² or more, 90 g/m² or more, or 95 g/m² or more). In some examples, the third fabric has an area density of 100 g/m² or less (e.g., 95 g/m² or less, 90 g/m² or less, 85 g/m² or less, 80 g/m² or less, 75 g/m² or less, 70 g/m² or less, 65 g/m² or less, 60 g/m² or less, 55 g/m² or less, 50 g/m² or less, 45 g/m² or less, 40 g/m² or less, 35 g/m² or less, 30 g/m² or less, 25 g/m² or less, 20 g/m² or less, or 15 g/m² or less). The area density of the third fabric can range from any of the minimum values described above to any of the maximum values described above. For example, the third fabric can have an area density of from to 100 g/m² (e.g., from 10 g/m² to 55 g/m², from 55 g/m² to 100 g/m², from 10 g/m² to 40 g/m², from 40 g/m² to 70 g/m², from 70 g/m² to 100 g/m², from 15 g/m² to 100 g/m², from 20 g/m² to 100 g/m², from 30 g/m² to 100 g/m², from 40 g/m² to 100 g/m², from 50 g/m² to 100 g/m², from 60 g/m² to 100 g/m², from 80 g/m² to 100 g/m², from 10 g/m² to 90 g/m², from 10 g/m² to 80 g/m², from 10 g/m² to 70 g/m², from 10 g/m² to 60 g/m², from 10 g/m² to 50 g/m², from 10 g/m² to 30 g/m², from 15 g/m² to 95 g/m², from 20 g/m² to 90 g/m², or from 20 g/m² to 50 g/m²).

In some examples, the third fabric has a tensile strength (warp/machine direction) of 1 MPa or more (e.g., 2 MPa or more, 3 MPa or more, 4 MPa or more, 5 MPa or more, 10 MPa or more, 15 MPa or more, 20 MPa or more, 25 MPa or more, 30 MPa or more, 35 MPa or more, 40 MPa or more, or 45 MPa or more). In some examples, the third fabric has a tensile strength (warp/machine direction) of 50 MPa or less (e.g., 45 MPa or less, 40 MPa or less, 35 MPa or less, 30 MPa or less, 25 MPa or less, 20 MPa or less, 15 MPa or less, 10 MPa or less, 5 MPa or less, 4 MPa or less, 3 MPa or less, or 2 MPa or less). The tensile strength (warp/machine direction) of the third fabric can range from any of the minimum values described above to any of the maximum values described above. For example, the third fabric can have a tensile strength (warp/machine direction) of from 1 to 50 MPa (e.g., from 1 MPa to 25 MPa, from 25 MPa to 50 MPa, from 1 MPa to 10 MPa, from 10 MPa to 20 MPa, from 20 MPa to 30 MPa, from 30 MPa to 40 MPa, from 40 MPa to 50 MPa, from 1 MPa to 40 MPa, from 1 MPa to 30 MPa, from 1 MPa to 20 MPa, from 1 MPa to 5 MPa, from 5 MPa to 50 MPa, from 10 MPa to 50 MPa, from MPa to 50 MPa, from 30 MPa to 50 MPa, from 5 MPa to 45 MPa, or from 10 MPa to 40 MPa).

In some examples, the third fabric has a tear strength (warp/machine direction) of 1 N or more (e.g., 2 N or more, 3 N or more, 4 N or more, 5 N or more, 6 N or more, 7 N or more, 8 N or more, 9 N or more, 10 N or more, 11 N or more, 12 N or more, 13 N or more, 14 N or more, N or more, 16 N or more, 17 N or more, 18 N or more, 19 N or more, 20 N or more, 21 N or more, 22 N or more, 23 N or more, or 24 N or more). In some examples, the third fabric has a tear strength (warp/machine direction) of 25 N or less (e.g., 24 N or less, 23 N or less, 22 N or less, 21 N or less, 20 N or less, 19 N or less, 18 N or less, 17 N or less, 16 N or less, 15 N or less, 14 N or less, 13 N or less, 12 N or less, 11 N or less, 10 N or less, 9 N or less, 8 N or less, 7 N or less, 6 N or less, 5 N or less, 4 N or less, 3 N or less, or 2 N or less). The tear strength (warp/machine direction) of the third fabric can range from any of the minimum values described above to any of the maximum values described above. For example, the third fabric can have a tear strength (warp/machine direction) of from 1 to 25 N (e.g., from 1 N to 12 N, from 12 N to 25 N, from 1 N to 5 N, from 5 N to 10 N, from 10 N to 15 N, from 15 N to 20 N, from 20 N to 25 N, from 5 N to 25 N, from 10 N to 25 N, from 15 N to 25 N, from 1 N to 20 N, from 1 N to 15 N, from 1 N to 10 N, from 2 N to 24 N, from 3 N to 23 N, from 4 N to 22 N, or from 5 N to 20 N).

In some examples, the ion permeable separator layer 110 comprises a plurality of layers of the third fabric.

In some examples, the first carbon fiber fabric and/or the second carbon fiber fabric is a woven, knitted, or non-woven fabric. The term “woven” as used herein includes weaves (such as plain weaves, twill weaves, and satin weaves), and knits.

In some examples, the first carbon fiber fabric and/or the second carbon fiber fabric has a carbon content of at least 95% by weight of the fabric (e.g., 95% or more, 96% or more, 97% or more, 98% or more, or 99% or more).

In some examples, the first carbon fiber fabric and/or the second carbon fiber fabric has a basis weight of 100 g/m² or more (e.g., 110 g/m² or more, 120 g/m² or more, 130 g/m² or more, 140 g/m² or more, 150 g/m² or more, 160 g/m² or more, 170 g/m² or more, 180 g/m² or more, 190 g/m² or more, 200 g/m² or more, 210 g/m² or more, 220 g/m² or more, 230 g/m² or more, or 240 g/m² or more). In some examples, the first carbon fiber fabric and/or the second carbon fiber fabric has a basis weight of 250 g/m² or less (e.g., 240 g/m² or less, 230 g/m² or less, 220 g/m² or less, 210 g/m² or less, 200 g/m² or less, 190 g/m² or less, 180 g/m² or less, 170 g/m² or less, 160 g/m² or less, 150 g/m² or less, 140 g/m² or less, 130 g/m² or less, 120 g/m² or less, or 110 g/m² or less). The basis weight of the first carbon fiber fabric and/or the second carbon fiber fabric can independently range from any of the minimum values described above to any of the maximum values described above. For example, the first carbon fiber fabric and/or the second carbon fiber fabric can have a basis weight of from 100 g/m² to 250 g/m² (e.g., from 100 g/m² to 175 g/m², from 175 g/m² to 250 g/m², from 100 g/m² to 150 g/m², from 150 g/m² to 200 g/m², from 200 g/m² to 250 g/m², from 125 g/m² to 250 g/m², from 150 g/m² to 250 g/m², from 200 g/m² to 250 g/m², from 225 g/m² to 250 g/m², from 100 g/m² to 225 g/m², from 100 g/m² to 200 g/m², from 100 g/m² to 150 g/m², from 100 g/m² to 125 g/m², from 110 g/m² to 240 g/m², from 120 g/m² to 230 g/m², or from 150 g/m² to 200 g/m²).

In some examples, the first carbon fiber fabric and/or the second carbon fiber fabric has an average thickness of 100 μm or more (e.g., 125 μm or more, 150 μm or more, 175 μm or more, 200 μm or more, 225 μm or more, 250 μm or more, 300 μm or more, 350 μm or more, 400 μm or more, 450 μm or more, 500 μm or more, 550 μm or more, 600 μm or more, 650 μm or more, 700 μm or more, 750 μm or more, 800 μm or more, 850 μm or more, 900 μm or more, or 950 μm or more). In some examples, the first carbon fiber fabric and/or the second carbon fiber fabric has an average thickness of 1000 μm or less (e.g., 950 μm or less, 900 μm or less, 850 μm or less, 800 μm or less, 750 μm or less, 700 μm or less, 650 μm or less, 600 μm or less, 550 μm or less, 500 μm or less, 450 μm or less, 400 μm or less, 350 μm or less, 300 μm or less, 250 μm or less, 225 μm or less, 200 μm or less, 175 μm or less, 150 μm or less, or 125 μm or less). The average thickness of the first carbon fiber fabric and/or the second carbon fiber fabric can independently range from any of the minimum values described above to any of the maximum values described above. For example, the first carbon fiber fabric and/or the second carbon fiber fabric has an average thickness of from 100 μm to 1000 μm (e.g., from 100 μm to 550 μm, from 550 μm to 1000 μm, from 100 μm to 400 μm, from 400 μm to 700 μm, from 700 μm to 1000 μm, from 100 μm to 900 μm, from 100 μm to 800 μm, from 100 μm to 700 μm, from 100 μm to 600 μm, from 100 μm to 500 μm, from 100 μm to 300 μm, from 100 μm to 200 μm, from 125 μm to 1000 μm, from 150 μm to 1000 μm, from 200 μm to 1000 μm, from 300 μm to 1000 μm, from 400 μm to 1000 μm, from 500 μm to 1000 μm, from 600 μm to 1000 μm, from 800 μm to 1000 μm, from 900 μm to 1000 μm, from 125 μm to 950 μm, from 150 μm to 900 μm, or from 200 μm to 800 μm).

In some examples, the first carbon fiber fabric and the second carbon fiber fabric are the same.

In some examples, the first current collector layer 130 and the second current collector layer 132 are the same.

In some examples, the first carbon fiber fabric and/or the second carbon fiber fabric independent comprise a commercial fabric such as those known in the art.

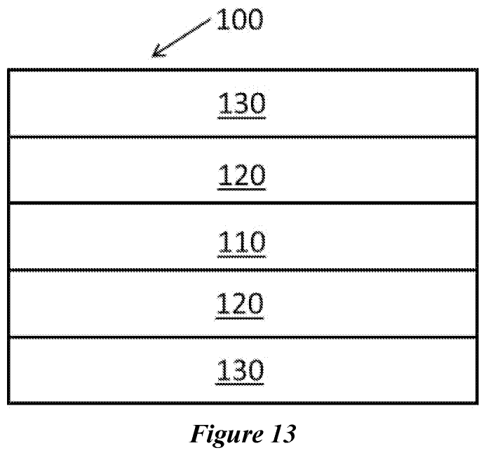

In some examples, the first electrode layer 120 and the second electrode layer 122 are the same and the first the first current collector layer 130 and the second current collector layer 132 are the same, as shown in FIG. 13.

For example, referring now to FIG. 13, also disclosed herein are fabric supercapacitors 100 comprising: an ion permeable separator layer 110; a first electrode layer 120; a second electrode layer 120; a first current collector layer 130; and a second current collector layer 130; wherein: the ion permeable separator layer 110 is disposed between (e.g., sandwiched between) the first electrode layer 120 and the second electrode layer 120, such that the ion permeable separator layer 110 is in physical and electrical contact with the first electrode layer 120 and the second electrode layer 120; the first electrode layer 120 is disposed between (e.g., sandwiched between) the first current collector layer 130 and the ion permeable separator layer 110, such that the first electrode layer 120 is in physical and electrical contact with both the first current collector layer 130 and the ion permeable separator layer 110; and the second electrode layer 120 is disposed between (e.g., sandwiched between) the ion permeable separator layer 110 and the second current collector layer 130, such that the second electrode layer 120 is in physical and electrical contact with both the ion permeable separator layer 110 and the second current collector layer 130.

In some examples, the fabric supercapacitor has a specific capacitance of 4 mF/cm² or more at a scan rate of 10 mV/s (e.g., 5 mF/cm² or more, 6 mF/cm² or more, 7 mF/cm² or more, 8 mF/cm² or more, 9 mF/cm² or more, 10 mF/cm² or more, 15 mF/cm² or more, 20 mF/cm² or more, 25 mF/cm² or more, 30 mF/cm² or more, 35 mF/cm² or more, 40 mF/cm² or more, 45 mF/cm² or more, 50 mF/cm² or more, 55 mF/cm² or more, 60 mF/cm² or more, 65 mF/cm² or more, 70 mF/cm² or more, 75 mF/cm² or more, 80 mF/cm² or more, 85 mF/cm² or more, 90 mF/cm² or more, or 95 mF/cm² or more).

In some examples, the fabric supercapacitor has an energy density of 5×10⁻⁴ Wh/cm² or more at a scan rate of 10 mV/s (e.g., 6×10⁴ Wh/cm² or more, 7×10⁻⁴ Wh/cm² or more, 8×10⁻⁴ Wh/cm² or more, 9×10⁻⁴ Wh/cm² or more, 10×10⁻⁴ Wh/cm² or more, 11×10⁻⁴ Wh/cm² or more, 12×10⁻⁴ Wh/cm² or more, 13×10⁻⁴ Wh/cm² or more, 14×10⁻⁴ Wh/cm² or more, 15×10⁻⁴ Wh/cm² or more, 16×10⁻⁴ Wh/cm² or more, 17×10⁻⁴ Wh/cm² or more, 18×10⁻⁴ Wh/cm² or more, 19×10⁻⁴ Wh/cm² or more, or 20×10⁻⁴ Wh/cm² or more).

In some examples, the fabric supercapacitor has a power density of 19 W/cm² or more at a scan rate of 10 mV/s (e.g., 20 W/cm² or more, 25 W/cm² or more, 30 W/cm² or more, 35 W/cm² or more, 40 W/cm² or more, 45 W/cm² or more, 50 W/cm² or more, 55 W/cm² or more, 60 W/cm² or more, 65 W/cm² or more, 70 W/cm² or more, 75 W/cm² or more, 80 W/cm² or more, 85 W/cm² or more, 90 W/cm² or more, or 95 W/cm² or more).

In some examples, the fabric supercapacitor has an average total thickness of 215 μm or more (e.g., 220 μm or more, 225 μm or more, 230 μm or more, 235 μm or more, 240 μm or more, 245 μm or more, 250 μm or more, 260 μm or more, 270 μm or more, 280 μm or more, 290 μm or more, 300 μm or more, 325 μm or more, 350 μm or more, 375 μm or more, 400 μm or more, 450 μm or more, 500 μm or more, 550 μm or more, 600 μm or more, 650 μm or more, 700 μm or more, 750 μm or more, 800 μm or more, 850 μm or more, 900 μm or more, 950 μm or more, 1000 μm or more, 1100 μm or more, 1200 μm or more, 1300 μm or more, 1400 μm or more, 1500 μm or more, 1750 μm or more, 2000 μm or more, 2250 μm or more, 2500 μm or more, 2750 μm or more, 3000 μm or more, 3500 μm or more, 4000 μm or more, 4500 μm or more, 5000 μm or more, 5500 μm or more, or 6000 μm or more). In some examples, the fabric supercapacitor has an average total thickness of 6500 μm or less (e.g., 6000 μm or less, 5500 μm or less, 5000 μm or less, 4500 μm or less, 4000 μm or less, 3500 μm or less, 3000 μm or less, 2750 μm or less, 2500 μm or less, 2250 μm or less, 2000 μm or less, 1750 μm or less, 1500 μm or less, 1400 μm or less, 1300 μm or less, 1200 μm or less, 1100 μm or less, 1000 μm or less, 950 μm or less, 900 μm or less, 850 μm or less, 800 μm or less, 750 μm or less, 700 μm or less, 650 μm or less, 600 μm or less, 550 μm or less, 500 μm or less, 450 μm or less, 400 μm or less, 375 μm or less, 350 μm or less, 325 μm or less, 300 μm or less, 290 μm or less, 280 μm or less, 270 μm or less, 260 μm or less, 250 μm or less, 245 μm or less, 240 μm or less, 235 μm or less, 230 μm or less, 225 μm or less, or 220 μm or less). The average total thickness of the fabric supercapacitor can range from any of the minimum values described above to any of the maximum values described above. For example, the fabric supercapacitor can have an average total thickness of from 215 μm to 6500 μm (e.g., from 215 μm to 3500 μm, from 3500 μm to 6500 μm, from 215 μm to 1000 μm, from 1000 μm to 2000 μm, from 2000 μm to 3000 μm, from 3000 μm to 4000 μm, from 4000 μm to 5000 μm, from 5000 μm to 6500 μm, from 225 μm to 6500 μm, from 250 μm to 6500 μm, from 300 μm to 6500 μm, from 400 μm to 6500 μm, from 500 μm to 6500 μm, from 750 μm to 6500 μm, from 1000 μm to 6500 μm, from 1500 μm to 6500 μm, from 2000 μm to 6500 μm, from 3000 μm to 6500 μm, from 4000 μm to 6500 μm, from 215 μm to 6000 μm, from 215 μm to 5000 μm, from 215 μm to 4000 μm, from 215 μm to 3000 μm, from 215 μm to 2000 μm, from 215 μm to 1500 μm, from 215 μm to 1000 μm, from 215 μm to 750 μm, from 215 μm to 500 μm, from 225 μm to 6000 μm, or from 250 μm to 5000 μm).

In some examples, the fabric supercapacitor has a total basis weight of 250 g/m² or more (e.g., 275 g/m² or more, 300 g/m² or more, 325 g/m² or more, 350 g/m² or more, 375 g/m² or more, 400 g/m² or more, 450 g/m² or more, 500 g/m² or more, 550 g/m² or more, 600 g/m² or more, 650 g/m² or more, 700 g/m² or more, 750 g/m² or more, 800 g/m² or more, 850 g/m² or more, 900 g/m² or more, or 950 g/m² or more). In some examples, the fabric supercapacitor has a total basis weight of 1000 g/m² or less (e.g., 950 g/m² or less, 900 g/m² or less, 850 g/m² or less, 800 g/m² or less, 750 g/m² or less, 700 g/m² or less, 650 g/m² or less, 600 g/m² or less, 550 g/m² or less, 500 g/m² or less, 450 g/m² or less, 400 g/m² or less, 375 g/m² or less, 350 g/m² or less, 325 g/m² or less, 300 g/m² or less, or 275 g/m² or less). The total basis weight of the fabric superconductor can range from any of the minimum values described above to any of the maximum values described above. For example, the fabric supercapacitor have a total basis weight of from 250 to 1000 g/m² (e.g., from 250 g/m² to 625 g/m², from 625 g/m² to 1000 g/m², from 250 g/m² to 500 g/m², from 500 g/m² to 750 g/m², from 750 g/m² to 1000 g/m², from 250 g/m² to 900 g/m², from 250 g/m² to 800 g/m², from 250 g/m² to 700 g/m², from 250 g/m² to 600 g/m², from 250 g/m² to 400 g/m², from 300 g/m² to 1000 g/m², from 400 g/m² to 1000 g/m², from 500 g/m² to 1000 g/m², from 600 g/m² to 1000 g/m², from 700 g/m² to 1000 g/m², from 800 g/m² to 1000 g/m², from 275 g/m² to 950 g/m², from 300 g/m² to 900 g/m², or from 400 g/m² to 800 g/m²).

In some examples, the layers of the fabric supercapacitor are held together via compressive force.

In some examples, the layers of the fabric supercapacitor are sewn together.

In some examples, the fabric supercapacitor is flexible.

In some examples, the fabric supercapacitor is substantially free of electrolyte liquids, electrolyte gels, polymer gels, adhesives, or a combination thereof.

Also disclosed herein are articles comprising any of the fabric supercapacitors disclosed herein. The article can, for example, be a garment, a housing (such as a tent), an umbrella, or a bag (such as a backpack).

### Methods of Making

Also disclosed herein are methods of making any of the fabric supercapacitors disclosed herein.

For example, the methods can comprise, in any order: disposing the first electrode layer 120 on the first current collector layer 130, disposing the ion permeable separator layer 110 on the first electrode layer 120, disposing the second electrode layer 122 the ion permeable separator layer 110, and disposing the second current collector layer 132 on the second electrode layer 122.

In some examples, the methods can further comprise making the first electrode layer 120, the second electrode layer 122, the ion permeable separator layer 110, or a combination thereof.

In some examples, the methods further comprise making the first electrode layer 120 by making the first fabric, the method comprising: spinning a first mixture of the first polymer and the first electrolyte to form a first precursor fabric, and depositing the first plurality of activated carbon granules on the first precursor fabric.

In some examples, the methods further comprise making the second electrode layer 122 by making the second fabric, the method comprising: spinning a second mixture of the second polymer and the second electrolyte to form a second precursor fabric, and depositing the second plurality of activated carbon granules on the second precursor fabric.

In some examples, the methods further comprises making the ion permeable separator layer 110 by making the third fabric, the method comprising: spinning a third mixture of the third polymer and the third electrolyte.

In some examples, the methods further comprise making the first mixture, the second mixture, the third mixture, or a combination thereof.

In some examples, the first mixture further comprises a first solvent, the second mixture further comprises a second solvent, the third mixture further comprises a third solvent, or a combination thereof.

In some examples, the first plurality of activated carbon granules are dispersed in a fourth solvent and/or the second plurality of activated carbon granules are dispersed in a fifth solvent.

The first solvent, the second solvent, the third solvent, the fourth solvent, the fifth solvent, or a combination thereof can independently comprise any suitable solvent. Examples of suitable solvents include, but are not limited to, tetrahydrofuran (THF), N-methyl-2-pyrrolidone (NMP), dimethylformamide (DMF), N-methylformamide, formamide, dimethyl sulfoxide (DMSO), dimethylacetamide, dichloromethane (CH₂Cl₂), ethylene glycol, polyethylene glycol, glycerol, alkane diol, tetraglyme, propylene carbonate, diglyme, dimethoxyethane, ethanol, methanol, propanol, isopropanol, water, acetonitrile, chloroform, acetone, hexane, heptane, toluene, xylene, methyl acetate, ethyl acetate, and combinations thereof.

In some examples, spinning the first mixture, the second mixture, the third mixture, or a combination thereof independently comprises electrospinning, wet jet fiber pulling, wet spinning, dry spinning, dry-jet wet spinning, centrifugal spinning, or combinations thereof. In some examples, spinning the first mixture, the second mixture, the third mixture, or a combination thereof independently comprises electrospinning or centrifugal spinning. In some examples, spinning the first mixture, the second mixture, the third mixture, or a combination thereof independently comprises centrifugal spinning.

In some examples, the methods further comprise agitating the first mixture, the second mixture, the third mixture, or a combination thereof before spinning. Agitating first mixture, the second mixture, the third mixture, or a combination thereof can be accomplished, for example, by mechanical stirring, shaking, vortexing, sonication (e.g., bath sonication, probe sonication, ultrasonication), and the like, or combinations thereof.

In some examples, the methods further comprise sewing the layers together.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1-Nanofiber-Structured Fabric Supercapacitor

Described herein are nanofiber-structured fabric supercapacitors (NANO-FSCs) and methods of making and use thereof.

Fabric supercapacitors have been previously described, for example in U.S. Pat. No. 10,199,180 B2, which is hereby incorporated herein for its description thereof.

Described herein are methods to produce nanofiber electrode fabric, methods to produce nanofiber separator fabric, and methods to assemble a fabric supercapacitor. Purpose of this development is to improve fabric supercapacitors, e.g. relative to those disclosed in U.S. Pat. No. 10,199,180, for example in terms of weight and thickness reduction, stiffness reduction, cost reduction, and energy density increase. The fabric supercapacitors described herein can be widely adopted by various end-use textile products as energy storage devices.

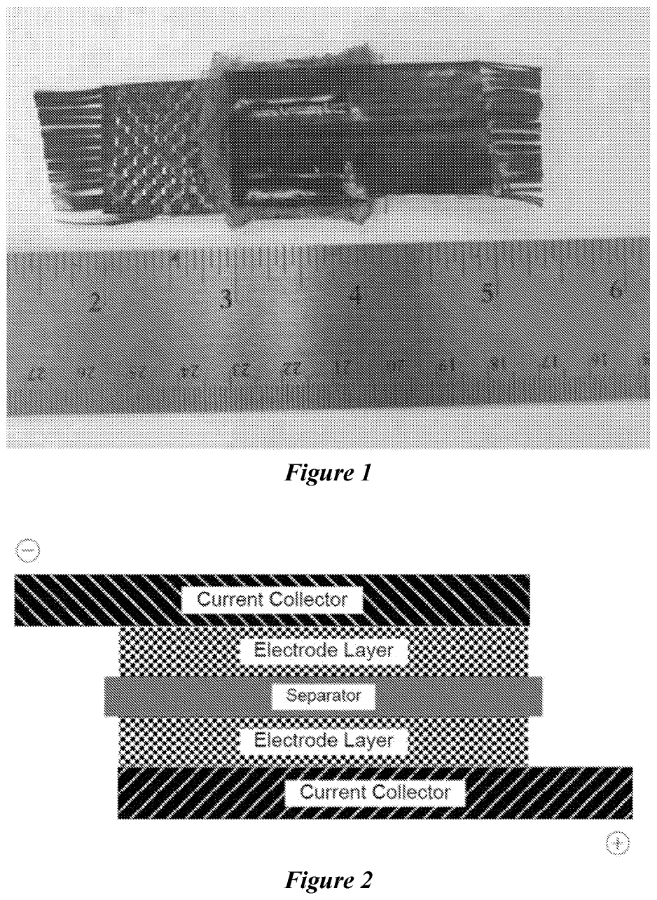

NANO-FSC Structure and Materials. The fabric supercapacitors described herein can have a layered-structure that can be symmetric. The layered-structure can, for example, comprise 2 electrode layers, 2 current collector layers, and one separator layer, as shown in FIG. 1-FIG. 2.

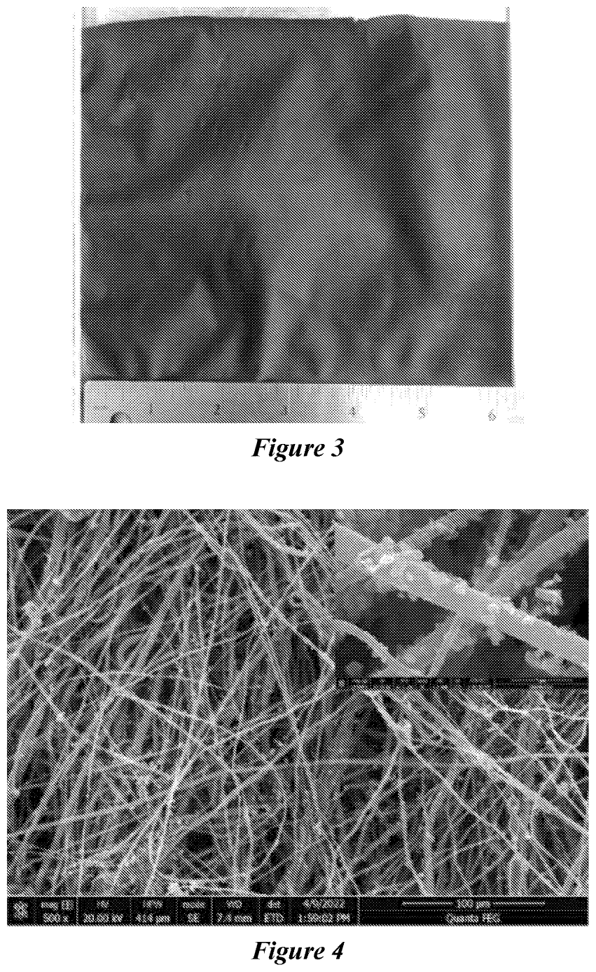

In some examples, the electrode layer is a PVA nanofiber nonwoven with a woven mesh as a substrate (FIG. 3). Phosphorus acid (H₃PO₄) can be embedded in the PVA nanofiber as an electrolyte. Activated carbon granules (ACG) can be encapsulated in the nanofiber web (FIG. 4).

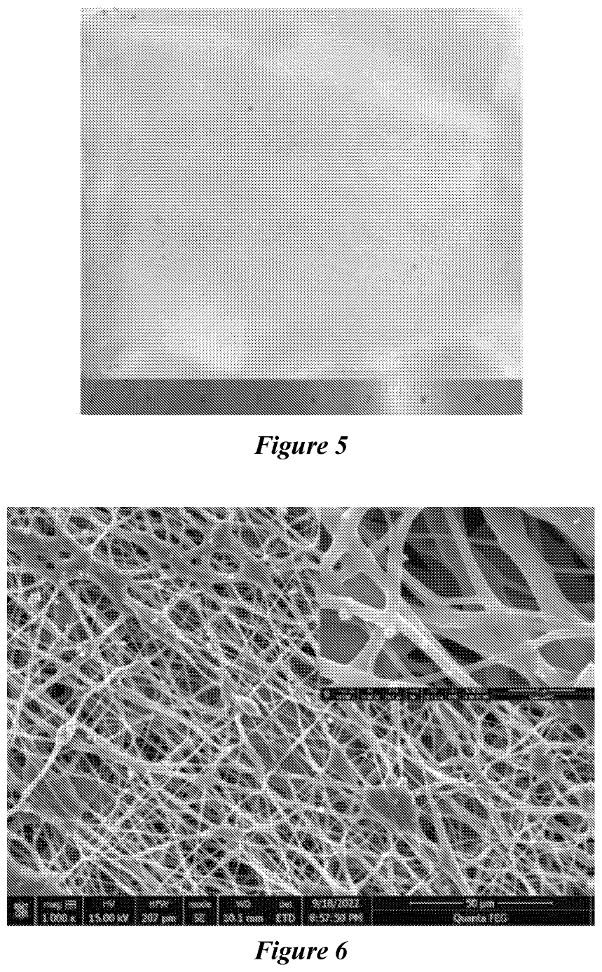

The separator layer can comprise three sublayers of PVA/H₃PO₄ nanofiber nonwoven deposited on both sides of the woven mesh substrate (FIG. 5-FIG. 6).

The current collector layer is a commercial carbon fiber fabric (plain weave).

The five fabric layers are superposed to form a NANO-FSC device by pressure. The multiple layers can also be stitched together by a sewing process.

Material Characteristics. Physical and mechanical properties of the electrode fabric, separator fabric, and current collector fabric were tested, and the results are summarized in Table 1.

TABLE 1
Fabric physical and mechanical properties

| | | | Tensile | Tear |
|---|---|---|---|---|
| | | Area | Strength | Strength |
| | Thickness | density | (Warp/MD) | (Warp/MD) |
| Layer | (mm) | (g/m²) | (MPa) | (N) |
| Current Collector | 0.310 | 196.5 | 41.850 | >instrument |
| | | | | scale |
| Woven mesh | 0.102 | 17.5 | 14.980 | 23.758 |
| substrate | | | | |
| Separator | 0.117 | 43.3 | 16.713 | 5.411 |
| Electrode | 0.163 | 78.5 | 4.352 | 8.339 |

*MD = Machine Direction

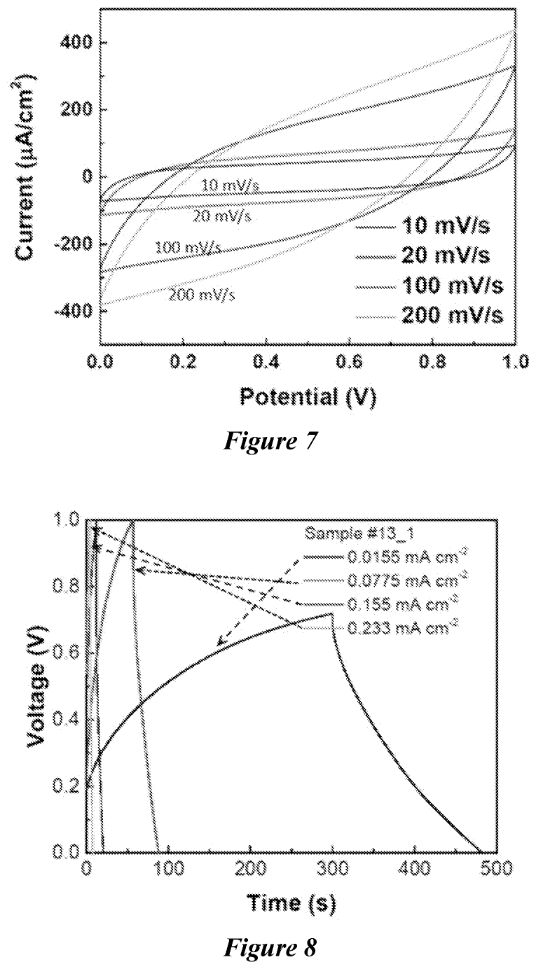

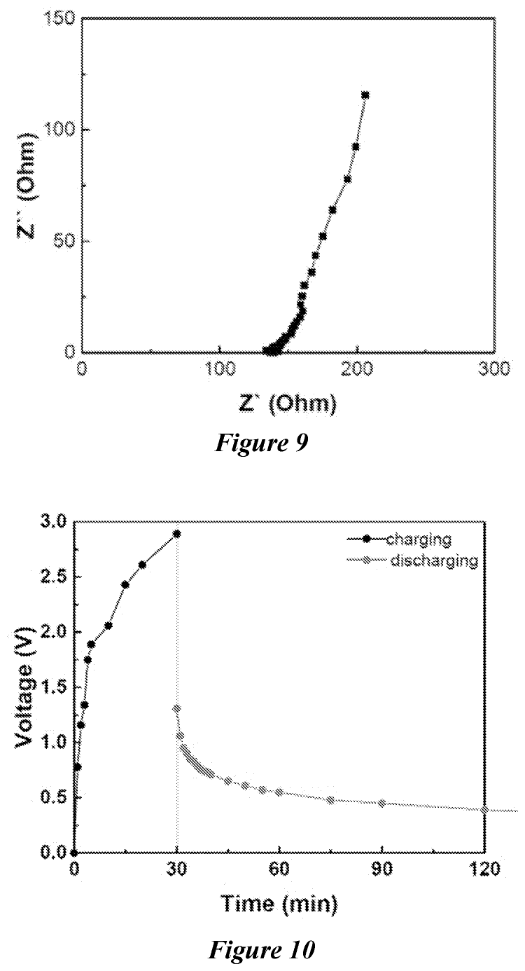

Electrochemical Properties of NANO-FSC Device. Electrochemical properties of the NANO-FSC device in terms of cyclic voltammetry (CV), galvanostatic charge-discharge (GCD), and electrochemical impedance spectra (EIS) were measured (FIG. 7-FIG. 9). All parameters of capacitance, equivalent series resistance, energy density, and power density are calculated and listed in Table 2, in comparison with a baseline FSC device (e.g., a device according to U.S. Pat. No. 10,199,180). FIG. 10 shows voltage changes of the NANO-FSC device in connection and disconnection with a solar cell (3.6 V, 50 mA).

TABLE 2
Electrochemical parameters of the NANO-FSC device.

| | Specific | | Equivalent | Energy | Power |
|---|---|---|---|---|---|
| | capacitance | Scan | series | density | density |
| FSC | (mF/ | Rate | resistance | (Wh/ | (W/ |
| Sample | cm²) | (mV/s) | (Ω) | cm²) | cm²) |
| Baseline | 7.991 | 10 | 1.01 | 11.1 × 10⁻⁴ | 39.955 |
| FSC | | | | | |
| NANO-FSC | 3.827 | 10 | 137 | 5.32 × 10⁻⁴ | 19.136 |

Method of Producing Electrode and Separator Fabrics. Approaches for fabricating the electrode and separator fabrics include preparation of PVA solution and ACG dispersion, nanofiber spinning, and FSC assembly.

Preparation of PVA Solution and ACG Dispersion. As an example experiment, 5 g of PVA (Acros Organics, MW 85000-124000) was dissolved in 50 ml distilled water through magnetic stirring and heating in 65° C. water bath for 1 hour. After a clear solution was formed, 5 g of H₃PO₄ was added and stirred for 30 minutes. Then, the PVA/H₃PO₄ solution was cooled at room temperature for 1 hour before nanofiber spinning. In a separate procedure, 5 g of ACG was dispersed in 300 ml DMF using an ultrasonic vibration device for 1 hour under room temperature.

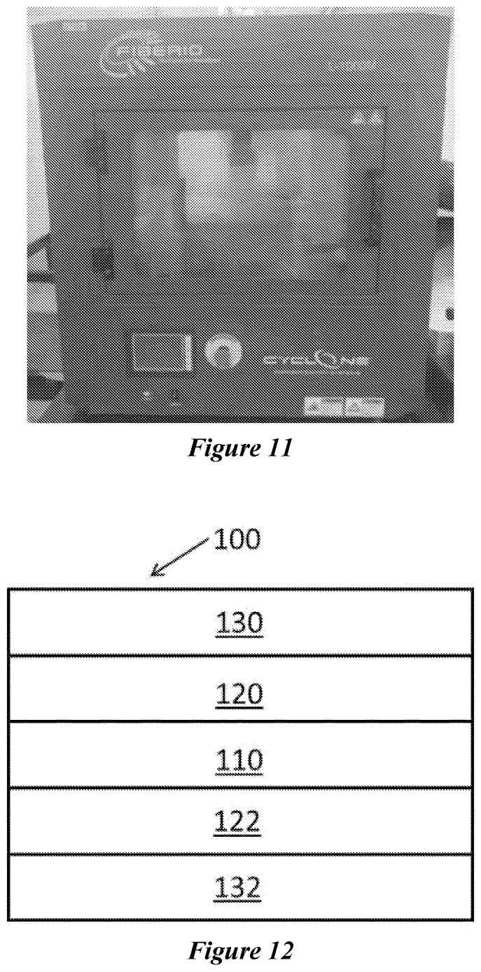

Nanofiber Nonwoven Production. The nanofiber nonwovens were fabricated using a centrifugal force spinning machine, Model FibeRio Cyclone L1000M, as shown in FIG. 11. For a spinning procedure to form electrode nanofiber nonwoven, 2 ml of PVA/H₃PO₄ solution was injected into a spinneret which was equipped with two 30 G needles. The PVA/H₃PO₄ nanofiber was spun off at 6000 rpm for 5 minutes and collected by a 6″×6″ screen covered by a woven mesh. After 5 cycles of spinning, the ACG dispersion solution was sprayed onto the deposited PVA/H₃PO₄ nanofiber and dried under 45° C. of temperature for 30 minutes. The above process of 5-cycle spinning and one ACG spray was repeated 4 times until the nanofiber nonwoven was produced with a designed thickness.

For a spinning procedure to form the separator nanofiber nonwoven, 2 ml of PVA/H₃PO₄ solution was injected into the spinneret and spun onto the woven mesh mounted on the screen with the same speed and time described above. After 10 cycles of spinning, the woven mesh was turned over on the screen for collecting the nanofiber web produced from another 10 cycles of spinning.

NANO-FSC Construction. Two electrode layers were cut from the PVA/H₃PO₄/ACG nanofiber nonwoven with a size of 1″×1″ square. Three sub-layers of separator were cut from the PVA/H₃PO₄ nanofiber nonwoven with a size of 1.1″×1.1″ square. Two current collector layers were cut from the carbon fiber woven fabric with a size of 1″×2.5″ rectangle. The NANO-FSC device was formed by stacking the electrode layer, current collector layer, and separator layer with a symmetric structure and clamping force (FIG. 2).

Alternatively, on each positive and negative side separated by the separator, the electrode layer and current collector layer could be sewn together with an individual sub-layer of separator using a conductive yarn. Then, the three sub-layers of separators are sewn together to bring all fabric layers together.

Discussion Recent development of supercapacitor (SC) technologies, including both double-layer capacitor (DLC) and pseudocapacitor, tried to shift capacitor performance from power density priority to energy density priority, so that SC could function as a battery. However, most SC constructions are sealed rigid button or tube to contain metal sheet conductor, carbon black electrode, and liquid electrolyte, nothing related to textile fabrics.

Although the existing fabric supercapacitors (U.S. Pat. No. 10,199,180 B2) introduced the use of carbon fiber fabric, activated carbon fiber fabric, and synthetic fiber mesh fabric for constructing SC current collector, electrode, and separator, a polymer gel matrix had to be used to carry electrolyte. As a result, the FSC described therein still showed a low flexibility because the fabric layers were bonded by the polymer gel.

In contrast to the existing SC technologies, the disclosed technology possesses at least three features/distinctions. First, the nanofiber web is used to encapsulate ACG for producing electrode fabric. Second, the nanofiber web is used as a matrix to provide the electrolyte H₃PO₄ in both the electrode layer and separator layer. Third, the sewing method is introduced to stitch all FSC layers together for assembly and function. Therefore, the developed technology is a complete departure from the present SC technologies. NANO-FSC is constructed by the fiber materials only. No electrolyte liquids and gels are used. Also, no adhesives are used in the formation of SC devices.

The NANO-FSC technology provides an approach to solve two major technical problems in SC fabrication. First, it eliminated the use of liquid or gel electrolytes. In the NANO-FSC device, the electrolyte was added into the PVA solution for nanofiber spinning. Thus, the electrolyte-filled fiber became an electrolyte carrier that enables the creation of a nanofiber nonwoven structure as an electrolyte matrix. The other problem being solved was scalability of the method to produce the electrode fabric. The formation of the electrode fabric in the NANO-FSC technology was based on the centrifugal force spinning technique. This method is commercially available and scalable in the production of nanofiber nonwovens. Therefore, the developed nanofiber electrode nonwoven could be directly adopted in mass production.

Based on the technical progress described above and compared with the previously developed FSC technology (U.S. Pat. No. 10,199,180 B2), the NANO-FSC technology includes, but is not limited to, one or more of the following advantages:
(1) Reduction of weight and thickness. The previous FSC device had a total weight of 776.0 g/m² and thickness of 1.492 mm. For the NANO-FSC device, the total weight and thickness were reduced to 679.9 g/m² and 1.295 mm.
(2) Reduction of rigidity. Because the NANO-FSC device was constructed by fiber assemblies only and no polymer gels were used for electrolyte, the device rigidity was reduced significantly towards flexible textile end uses.
(3) Reduction of material cost. In the NANO-FSC device, biobased ACG (produced from agricultural residues) was used in place of expensive activated carbon fiber materials use in the previous FSC. With this change of raw carbon material, the cost for electrode material that accounts for a large portion of total material use could be reduced by about 80%.

The NANO-FSC technology developed demonstrated that a supercapacitor can be made by all fabric materials after electrode and electrolyte components were integrated into fiber and fiber assembly structures.

However, the elimination of liquid or gel electrolyte and use of limited mass of carbon electrode can negatively affect SC energy density. Technical approaches for overcoming this include, but are not limited to: (1) selection of more efficient electrolytes; (2) use of transition metal nanoparticles to improve electrochemical properties; (3) increase of ACG loading in the nanofiber web; and (4) conversion of the SC structure into a battery structure.

### Example 2

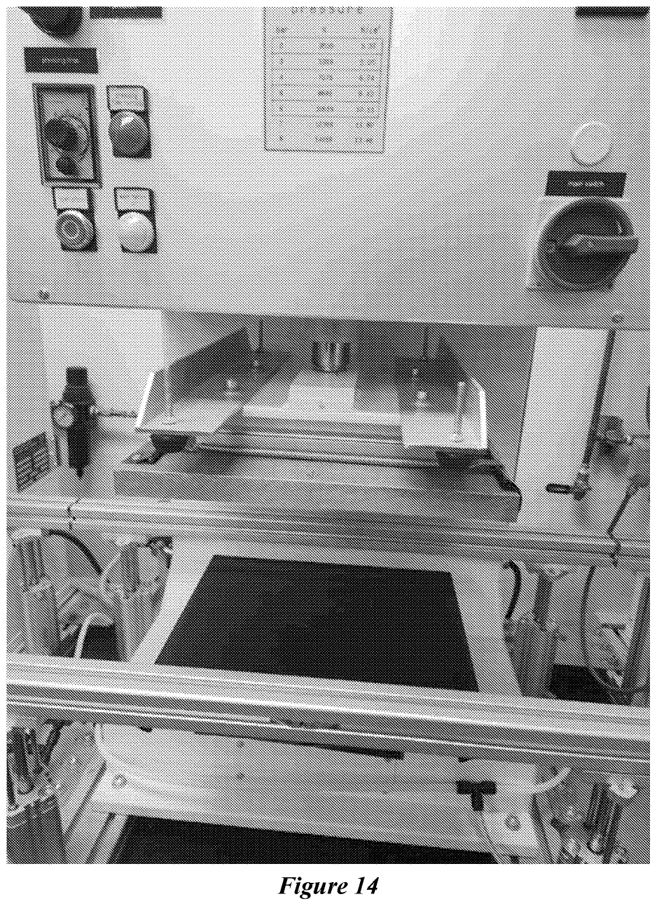

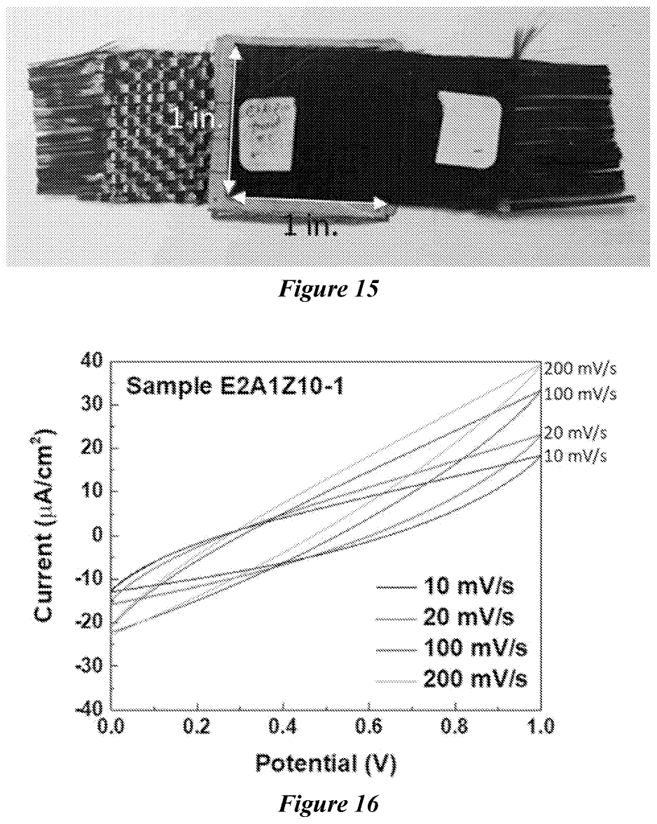

Effect of Pressure on Supercapacitor Electrochemical Properties. A Lab-Scale Press (FIG. 14) was used to press the electrode and electrolyte nanofiber layers after they were assembled into the fabric supercapacitor (FSC). The pressure applied uniformly on the experimental FSC sample (FIG. 15) was 2 and 3 bars individually. All electrochemical properties were tested and compared between the supercapacitor with pressed electrode and electrolyte layers and the supercapacitor with non-pressed electrode and electrolyte layers.

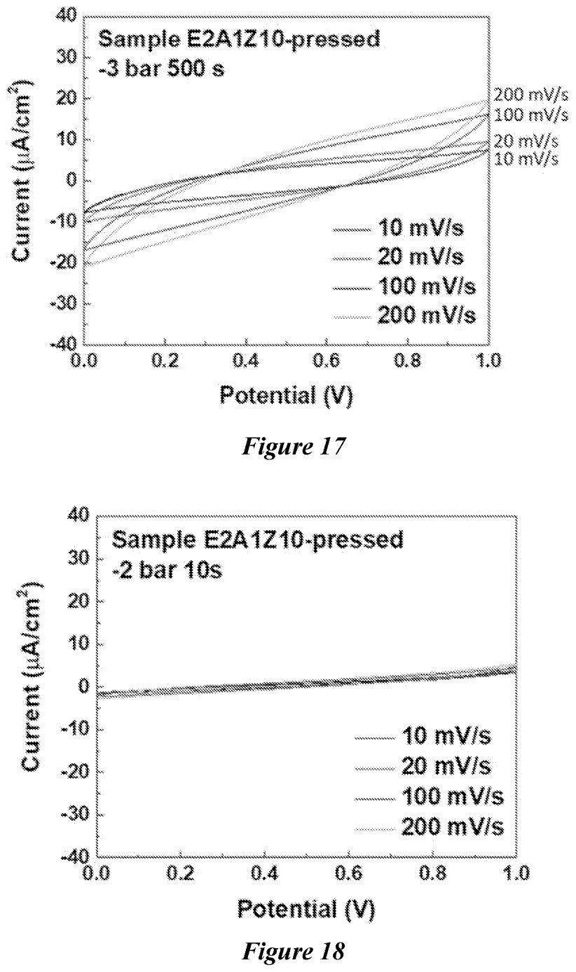

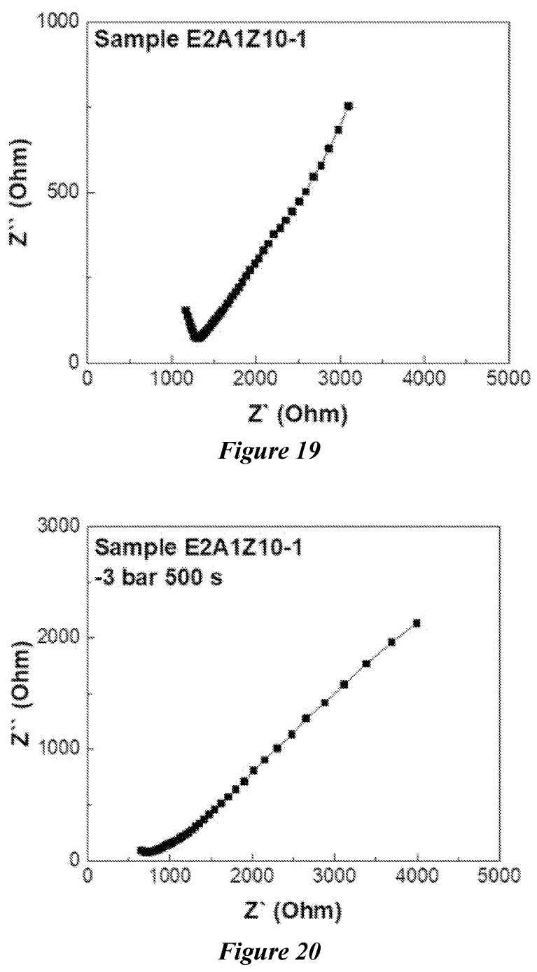

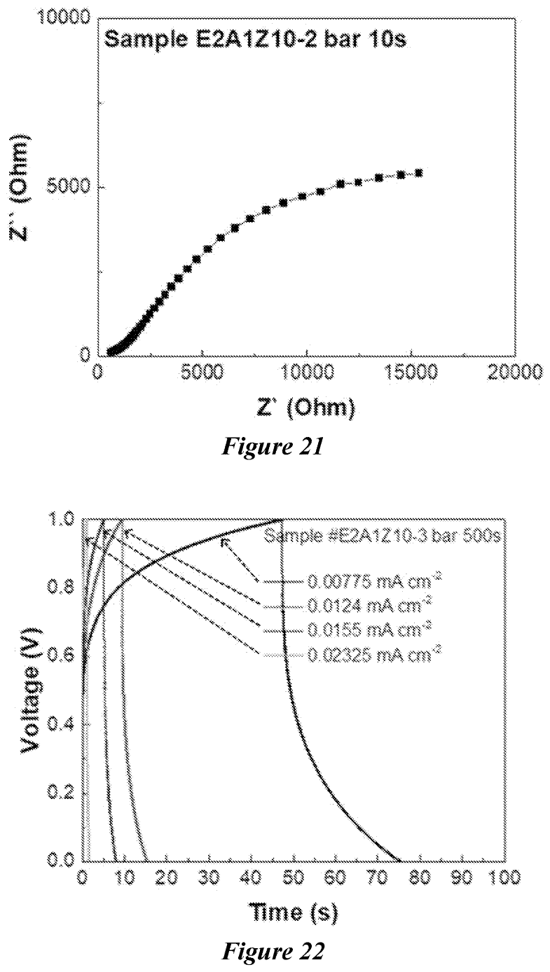

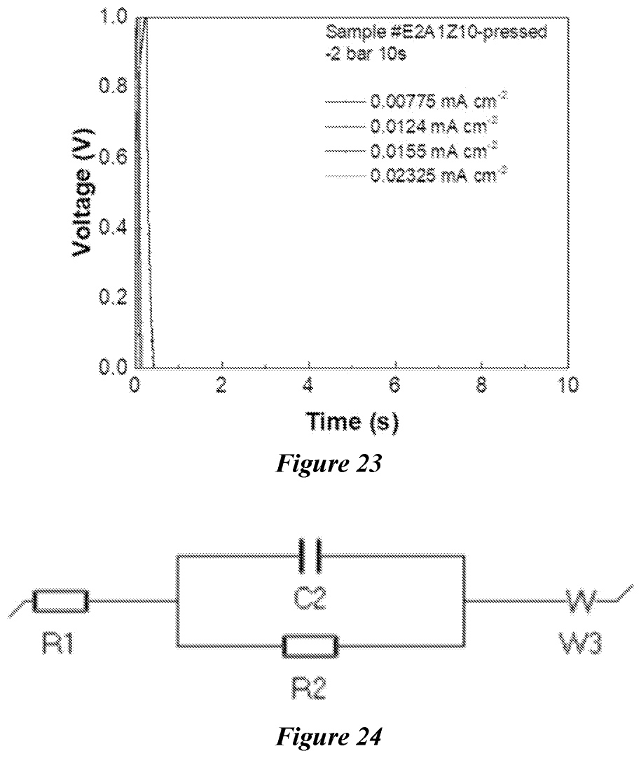

Listed in Table 3 are calculated supercapacitor properties of the experimental sample (E2A1Z10) before and after pressing, in terms of capacitance, energy density and power density. FIG. 16-FIG. 18 show the results of cyclic voltammetry (CV) measurements. Electrochemical impedance spectra (EIS) of the experimental FSC samples are plotted in FIG. 19-FIG. 21. For the pressed FSC samples, measured galvanostatic charge-discharge (GCD) behavior is shown in FIG. 22-FIG. 23. As the test results indicated, a pressing procedure during the FSC assembly reduced the capacitive performance. This phenomenon revealed that the electrode and electrolyte layers formed by the nanofiber structure were sensitive to compression. It was also found that how the compression affects the FSC electrochemical properties depends on pressing load and time.

TABLE 3
Comparison of fabric supercapacitor performance

| | Specific | Scan | Energy | Power |
|---|---|---|---|---|
| | capacitance | rate | density | density |
| Sample | (mF/cm²) | (mV/s) | (Wh/cm²) | (W/cm²) |
| E2A1Z10-1 without | 0.389 | 10 | 54.049 | 1.946 |
| press (control) | | | | |
| E2A1Z10 pressed at | 0.227 | 10 | 31.551 | 1.136 |
| 3 bars for 500 s | | | | |
| E2A1Z10 pressed at | 0.017 | 10 | 2.418 | 0.087 |
| 2 bars for 10 s | | | | |

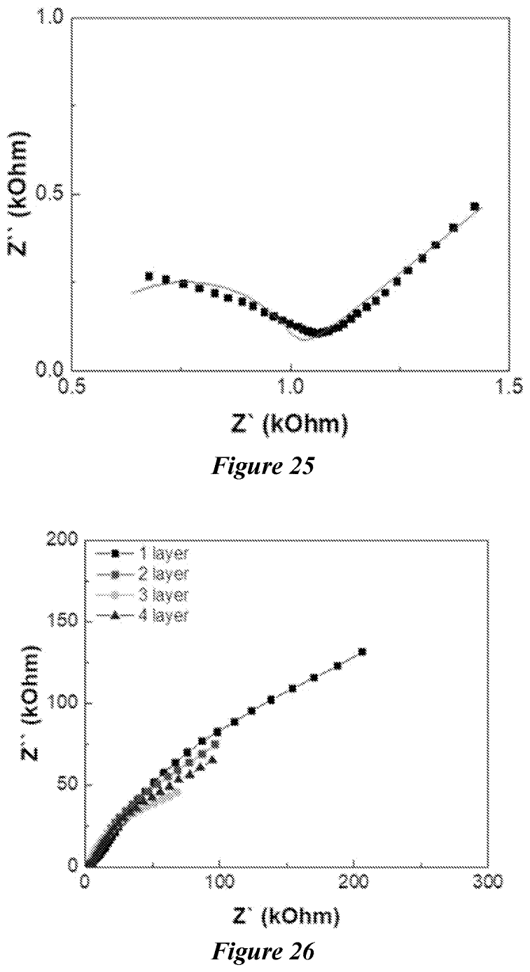

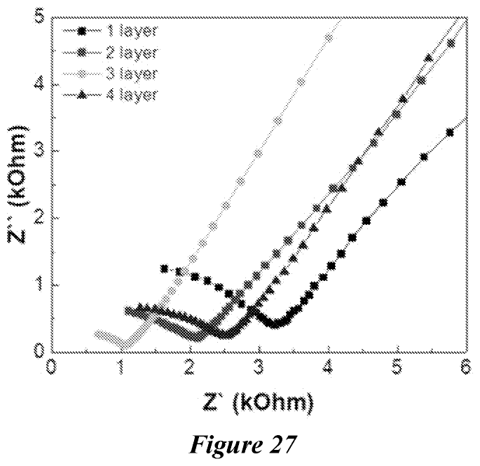

Conductivity of the Electrolyte Layer. The conductivity of the electrolyte layer of PVA/H₃PO₄ nanofiber was studied in order to understand ionic (proton) conductivity of the electrolyte layer. Various number of layers of the same PVA electrolyte were tested in order to see the effect of the thickness on the FSC total conductivity. Table 4 lists the measured results. The calculation is based on the equivalent electric circuit illustrated in FIG. 24. As a result, adequate curve fitting could be found, as shown in FIG. 25. FIG. 26-FIG. 27 plot the measured Nyquist curves in both low and high frequency regions for a comparison among different number of electrolyte layer. As the result indicates, when the number of nanofiber electrolyte layer increases, the conductivity of the total electrolyte also increases. This also follows up with the fact that when the number of the electrolyte layer in FSCs is increased, the FSC capacitance is also enhanced. An optimum thickness formed by superposition of the electrolyte layers can be determined, because increasing too much of the electrolyte layer thickness will induce a higher resistance in the electric circuit.

TABLE 4
Effect of the electrolyte layer thickness on the conductivity.

| | | Average | |
|---|---|---|---|
| Number of | Average | Bulk | Average |
| Electrolyte | Thickness | Resistance | Conductivity |
| Layer | (cm) | (Ω) | (S cm⁻¹) |
| 1 | 0.002 | 552.433 | 5.991 × 10⁻⁶ |
| 2 | 0.006 | 427.233 | 3.094 × 10⁻⁵ |
| 3 | 0.010 | 345.067 | 5.036 × 10⁻⁵ |
| 4 | 0.014 | 538.533 | 5.558 × 10⁻⁵ |

### Exemplary Aspects

In view of the described fabric devices, such as fabric supercapacitors, and methods of making and use thereof, herein below are described certain more particularly described aspects of the inventions. The particularly recited aspects should not, however, be interpreted to have any limiting effect on any different claims containing different or more general teaching described herein or that the “particular” aspects are somehow limited in some way other than the inherent meanings of the language and formulas literally used therein.

Example 1: A fabric supercapacitor comprising: an ion permeable separator layer; a first electrode layer; a second electrode layer; a first current collector layer; and a second current collector layer; wherein: the ion permeable separator layer is disposed between (e.g., sandwiched between) the first electrode layer and the second electrode layer, such that the ion permeable separator layer is in physical and electrical contact with the first electrode layer and the second electrode layer; the first electrode layer is disposed between (e.g., sandwiched between) the first current collector layer and the ion permeable separator layer, such that the first electrode layer is in physical and electrical contact with both the first current collector layer and the ion permeable separator layer; the second electrode layer is disposed between (e.g., sandwiched between) the ion permeable separator layer and the second current collector layer, such that the second electrode layer is in physical and electrical contact with both the ion permeable separator layer and the second current collector layer; the first electrode layer comprises a first fabric comprising a first plurality of fibers, the first plurality of fibers comprising a first polymer, and the first fabric further comprising a first electrolyte and a first plurality of activated carbon granules disposed therein; the second electrode layer comprises a second fabric comprises a second plurality of fibers, the second plurality of fibers comprising a second polymer, the second fabric further comprising a second electrolyte and a second plurality of activated carbon granules disposed therein; the ion permeable separator layer comprising a third fabric comprising a third plurality of fibers, the third plurality of fibers comprising a third polymer, the third fabric further comprising a third electrolyte disposed therein; the first current collector layer comprising a first carbon fiber fabric; and the second current collector layer comprising a second carbon fiber fabric.

Example 2: The fabric supercapacitor of any examples herein, particularly example 1, wherein the first fabric, the second fabric, the third fabric, or a combination thereof is a nonwoven fabric.

Example 3: The fabric supercapacitor of any examples herein, particularly example 1 or example 2, wherein the first fabric, the second fabric, the third fabric, or a combination thereof further comprises a mesh substrate, the plurality of fibers being disposed on the mesh substrate.

Example 4: The fabric supercapacitor of any examples herein, particularly example 3, wherein the mesh substrate comprises a fabric mesh substrate, such as a woven mesh substrate.

Example 5: The fabric supercapacitor of any examples herein, particularly examples 1-4, wherein the first polymer, the second polymer, the third polymer, or a combination thereof independently comprises a polyamide, a polyolefin, a polyester, a cellulose, a starch, a polyacrylonitrile, a vinyl polymer, or a combination thereof.

Example 6: The fabric supercapacitor of any examples herein, particularly examples 1-5, wherein the first polymer, the second polymer, the third polymer, or a combination thereof independently comprises a polyvinyl alcohol, polyvinyl acetate, starch, or combinations thereof.

Example 7: The fabric supercapacitor of any examples herein, particularly examples 1-6, wherein the first polymer, the second polymer, and the third polymer each independently comprises a polyvinyl alcohol.

Example 8: The fabric supercapacitor of any examples herein, particularly examples 1-7, wherein the first plurality of fibers, the second plurality of fibers, the third plurality of fibers, or a combination thereof independently have an average diameter of from 1 nanometer to 1 micrometer.

Example 9: The fabric supercapacitor of any examples herein, particularly examples 1-8, wherein the first electrolyte, the second electrolyte, the third electrolyte, or a combination thereof independently comprises a metal salt such as a metal hydroxide, phosphoric acid, sulfuric acid, or a combination thereof.

Example 10: The fabric supercapacitor of any examples herein, particularly examples 1-9, wherein the first electrolyte, the second electrolyte, the third electrolyte, or a combination thereof independently comprises a lithium salt, potassium hydroxide, phosphoric acid, sulfuric acid, or a combination thereof.

Example 11: The fabric supercapacitor of any examples herein, particularly examples 1-10, wherein the first electrolyte, the second electrolyte, the third electrolyte, or a combination thereof independently comprises H₃PO₄.

Example 12: The fabric supercapacitor of any examples herein, particularly examples 1-11, wherein the first fabric, the second fabric, the third fabric, or a combination thereof independently has an average thickness of 5 μm to 1500 μm.

Example 13: The fabric supercapacitor of any examples herein, particularly examples 1-12, wherein the first fabric and/or the second fabric has an area density of from 10 to 200 g/m².

Example 14: The fabric supercapacitor of any examples herein, particularly examples 1-13, wherein the first fabric and/or the second fabric has a tensile strength (warp/machine direction) of from 1 to 50 MPa.

Example 15: The fabric supercapacitor of any examples herein, particularly examples 1-14, wherein the first fabric and/or the second fabric has a tear strength (warp/machine direction) of from 1 to 25 N.

Example 16: The fabric supercapacitor of any examples herein, particularly examples 1-15, wherein: the first fabric comprises the first plurality of activated carbon granules in an amount of from 7.5% to 95% by weight, based on the total weight of the first fabric; the second fabric comprises the second plurality of activated carbon granules in an amount of from 7.5% to 95% by weight, based on the total weight of the second fabric; or a combination thereof.

Example 17: The fabric supercapacitor of any examples herein, particularly examples 1-16, wherein the first fabric further comprises a first plurality of conductive particles disposed therein, the second fabric further comprises a second plurality of conductive particles disposed therein, or a combination thereof.

Example 18: The fabric supercapacitor of any examples herein, particularly example 17, wherein the first plurality of conductive particles comprise a first metal and/or a first metal oxide, the second plurality of conductive particles comprise a second metal and/or a second metal oxide, or a combination thereof.

Example 19: The fabric supercapacitor of any examples herein, particularly examples 17-18, wherein the first plurality of conductive particles and the second plurality of conductive particles are the same.

Example 20: The fabric supercapacitor of any examples herein, particularly examples 1-19, wherein the first fabric and the second fabric are the same.

Example 21: The fabric supercapacitor of any examples herein, particularly examples 1-20, wherein the first electrode layer and the second electrode layer are the same.

Example 22: The fabric supercapacitor of any examples herein, particularly examples 1-21, wherein the third fabric has an area density of from 10 to 100 g/m².

Example 23: The fabric supercapacitor of any examples herein, particularly examples 1-22, wherein the third fabric has a tensile strength (warp/machine direction) of from 1 MPa to 50 MPa.

Example 24: The fabric supercapacitor of any examples herein, particularly examples 1-23, wherein the third fabric has a tear strength (warp/machine direction) of from 1 to 25 N.

Example 25: The fabric supercapacitor of any examples herein, particularly examples 1-24, wherein the ion permeable separator layer comprises a plurality of layers of the third fabric.

Example 26: The fabric supercapacitor of any examples herein, particularly examples 1-25, wherein the first carbon fiber fabric and/or the second carbon fiber fabric is a woven, knitted, or non-woven fabric.

Example 27: The fabric supercapacitor of any examples herein, particularly examples 1-26, wherein the first carbon fiber fabric and/or the second carbon fiber fabric has a carbon content of at least 95% by weight of the fabric.

Example 28: The fabric supercapacitor of any examples herein, particularly examples 1-27, wherein the first carbon fiber fabric and/or the second carbon fiber fabric has a basis weight of from 100 g/m² to 250 g/m².

Example 29: The fabric supercapacitor of any examples herein, particularly examples 1-28, wherein the first carbon fiber fabric and/or the second carbon fiber fabric has an average thickness of 100 μm to 1000 μm.

Example 30: The fabric supercapacitor of any examples herein, particularly examples 1-29, wherein the first carbon fiber fabric and the second carbon fiber fabric are the same.

Example 31: The fabric supercapacitor of any examples herein, particularly examples 1-30, wherein the first current collector layer and the second current collector layer are the same.

Example 32: The fabric supercapacitor of any examples herein, particularly examples 1-31, wherein the fabric supercapacitor has a specific capacitance of 4 mF/cm² or more at a scan rate of 10 mV/s.

Example 33: The fabric supercapacitor of any examples herein, particularly examples 1-32, wherein the fabric supercapacitor has an energy density of 5×10⁻⁴ Wh/cm² or more at a scan rate of 10 m V/s.

Example 34: The fabric supercapacitor of any examples herein, particularly examples 1-33, wherein the fabric supercapacitor has a power density of 19 W/cm² or more at a scan rate of mV/s.

Example 35: The fabric supercapacitor of any examples herein, particularly examples 1-34, wherein the fabric supercapacitor has an average total thickness of from 215 μm to 6500 μm.

Example 36: The fabric supercapacitor of any examples herein, particularly examples 1-35, wherein the fabric supercapacitor has a total basis weight of from 250 to 1000 g/m².

Example 37: The fabric supercapacitor of any examples herein, particularly examples 1-36, wherein the layers of the fabric supercapacitor are held together via compressive force.

Example 38: The fabric supercapacitor of any examples herein, particularly examples 1-37, wherein the layers of the fabric supercapacitor are sewn together.

Example 39: The fabric supercapacitor of any examples herein, particularly examples 1-38, wherein the fabric supercapacitor is flexible.

Example 40: The fabric supercapacitor of any examples herein, particularly examples 1-39, wherein the fabric supercapacitor is substantially free of electrolyte liquids, electrolyte gels, polymer gels, adhesives, or a combination thereof.

Example 41: An article comprising the fabric supercapacitor of any examples herein, particularly examples 1-40.

Example 42: The article of any examples herein, particularly example 41, wherein the article is a garment, a housing (such as a tent), an umbrella, or a bag (such as a backpack).

Example 43: A method of producing the fabric supercapacitor of any examples herein, particularly examples 1-42, the method comprising: disposing the first electrode layer on the first current collector layer, disposing the ion permeable separator layer on the first electrode layer, disposing the second electrode layer the ion permeable separator layer, and disposing the second current collector layer on the second electrode layer.

Example 44: The method of any examples herein, particularly example 43, wherein the method further comprises making the first electrode layer, the second electrode layer, the ion permeable separator layer, or a combination thereof.

Example 45: The method of any examples herein, particularly example 43 or example 44, wherein the method further comprises making the first electrode layer by making the first fabric, the method comprising: spinning a first mixture of the first polymer and the first electrolyte to form a first precursor fabric, and depositing the first plurality of activated carbon granules on the first precursor fabric.

Example 46: The method of any examples herein, particularly examples 43-45, wherein the method further comprises making the second electrode layer by making the second fabric, the method comprising: spinning a second mixture of the second polymer and the second electrolyte to form a second precursor fabric, and depositing the second plurality of activated carbon granules on the second precursor fabric.

Example 47: The method of any examples herein, particularly examples 43-46, wherein the method further comprises making the ion permeable separator layer by making the third fabric, the method comprising: spinning a third mixture of the third polymer and the third electrolyte.

Example 48: The method of any examples herein, particularly examples 45-47, wherein the first mixture further comprises a first solvent, the second mixture further comprises a second solvent, the third mixture further comprises a third solvent, or a combination thereof.

Example 49: The method of any examples herein, particularly examples 45-48, further comprising making the first mixture, the second mixture, the third mixture, or a combination thereof.

Example 50: The method of any examples herein, particularly examples 45-49, wherein the first plurality of activated carbon granules are dispersed in a fourth solvent and/or the second plurality of activated carbon granules are dispersed in a fifth solvent.

Example 51: The method of any examples herein, particularly examples 45-50, wherein spinning the first mixture, the second mixture, the third mixture, or a combination thereof independently comprises centrifugal spinning.

Example 52: The method of any examples herein, particularly examples 45-51, further comprising agitating the first mixture, the second mixture, the third mixture, or a combination thereof before spinning.

Example 53: The method of any examples herein, particularly examples 43-52, further comprising sewing the layers together.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

1. A fabric supercapacitor comprising:
an ion permeable separator layer;
a first electrode layer;
a second electrode layer;
a first current collector layer; and
a second current collector layer;
wherein:
the ion permeable separator layer is sandwiched between the first electrode layer and the second electrode layer, such that the ion permeable separator layer is in physical and electrical contact with the first electrode layer and the second electrode layer;
the first electrode layer is sandwiched between the first current collector layer and the ion permeable separator layer, such that the first electrode layer is in physical and electrical contact with both the first current collector layer and the ion permeable separator layer;
the second electrode layer is sandwiched between the ion permeable separator layer and the second current collector layer, such that the second electrode layer is in physical and electrical contact with both the ion permeable separator layer and the second current collector layer;
the first electrode layer comprises a first fabric comprising a first plurality of fibers, the first plurality of fibers comprising a first polymer, and the first fabric further comprising a first electrolyte and a first plurality of activated carbon granules disposed therein;
the second electrode layer comprises a second fabric comprises a second plurality of fibers, the second plurality of fibers comprising a second polymer, the second fabric further comprising a second electrolyte and a second plurality of activated carbon granules disposed therein;
the ion permeable separator layer comprising a third fabric comprising a third plurality of fibers, the third plurality of fibers comprising a third polymer, the third fabric further comprising a third electrolyte disposed therein;
the first current collector layer comprising a first carbon fiber fabric; and
the second current collector layer comprising a second carbon fiber fabric.

2. The fabric supercapacitor of claim 1, wherein the first fabric, the second fabric, the third fabric, or a combination thereof is a nonwoven fabric.

3. The fabric supercapacitor of claim 1, wherein the first fabric, the second fabric, the third fabric, or a combination thereof further comprises a mesh substrate, the plurality of fibers being disposed on the mesh substrate.

4. (canceled)

5. The fabric supercapacitor of claim 1, wherein the first polymer, the second polymer, the third polymer, or a combination thereof independently comprises a polyamide, a polyolefin, a polyester, a cellulose, a starch, a polyacrylonitrile, a vinyl polymer, or a combination thereof.

6. (canceled)

7. (canceled)

8. (canceled)

9. (canceled)

10. The fabric supercapacitor of claim 1, wherein the first electrolyte, the second electrolyte, the third electrolyte, or a combination thereof independently comprises a lithium salt, potassium hydroxide, phosphoric acid, sulfuric acid, or a combination thereof.

11. (canceled)

12. (canceled)

13. The fabric supercapacitor of claim 1, wherein the first fabric and/or the second fabric has:
an area density of from 10 to 200 g/m²;
a tensile strength (warp/machine direction) of from 1 to 50 MPa;
a tear strength (warp/machine direction) of from 1 to 25 N;
an average thickness of 5 μm to 1500 μm;
or a combination thereof.

14. (canceled)

15. (canceled)

16. The fabric supercapacitor of claim 1, wherein:
the first fabric comprises the first plurality of activated carbon granules in an amount of from 7.5% to 95% by weight, based on the total weight of the first fabric;
the second fabric comprises the second plurality of activated carbon granules in an amount of from 7.5% to 95% by weight, based on the total weight of the second fabric;
or a combination thereof.

17. The fabric supercapacitor of claim 1, wherein the first fabric further comprises a first plurality of conductive particles disposed therein, the second fabric further comprises a second plurality of conductive particles disposed therein, or a combination thereof.

18. (canceled)

19. (canceled)

20. The fabric supercapacitor of claim 1, wherein the first fabric and the second fabric are the same; wherein the first electrode layer and the second electrode layer are the same; or a combination thereof.

21. (canceled)

22. The fabric supercapacitor of claim 1, wherein the third fabric has:
an area density of from 10 to 100 g/m²;
a tensile strength (warp/machine direction) of from 1 MPa to 50 MPa;
a tear strength (warp/machine direction) of from 1 to 25 N;
an average thickness of 5 μm to 1500 μm;
or a combination thereof.

23. (canceled)

24. (canceled)

25. The fabric supercapacitor of claim 1, wherein the ion permeable separator layer comprises a plurality of layers of the third fabric.

26. The fabric supercapacitor of claim 1, wherein the first carbon fiber fabric and/or the second carbon fiber fabric is a woven, knitted, or non-woven fabric.

27. The fabric supercapacitor of claim 1, wherein the first carbon fiber fabric and/or the second carbon fiber fabric has:
a carbon content of at least 95% by weight of the fabric;
a basis weight of from 100 g/m² to 250 g/m²;
an average thickness of 100 μm to 1000 μm;
or a combination thereof.

28. (canceled)

29. (canceled)

30. The fabric supercapacitor of claim 1, wherein the first carbon fiber fabric and the second carbon fiber fabric are the same; wherein the first current collector layer and the second current collector layer are the same; or a combination thereof.

31. (canceled)

32. The fabric supercapacitor of claim 1, wherein the fabric supercapacitor has:
a specific capacitance of 4 mF/cm² or more at a scan rate of 10 mV/s;
an energy density of 5×10⁻⁴ Wh/cm² or more at a scan rate of 10 mV/s;
a power density of 19 W/cm² or more at a scan rate of 10 mV/s;
an average total thickness of from 215 μm to 6500 μm;
a total basis weight of from 250 to 1000 g/m²;
or a combination thereof.

33. (canceled)

34. (canceled)

35. (canceled)

36. (canceled)

37. The fabric supercapacitor of claim 1, wherein the layers of the fabric supercapacitor are held together via compressive force or wherein the layers of the fabric supercapacitor are sewn together.

38. (canceled)

39. The fabric supercapacitor of claim 1, wherein the fabric supercapacitor is flexible.

40. The fabric supercapacitor of claim 1, wherein the fabric supercapacitor is substantially free of electrolyte liquids, electrolyte gels, polymer gels, adhesives, or a combination thereof.

41. An article comprising the fabric supercapacitor of claim 1, wherein the article is a garment, a housing, an umbrella, or a bag.

42. (canceled)

43. A method of producing the fabric supercapacitor of claim 1, the method comprising:
disposing the first electrode layer on the first current collector layer,
disposing the ion permeable separator layer on the first electrode layer,
disposing the second electrode layer the ion permeable separator layer, and
disposing the second current collector layer on the second electrode layer.

44.-53. (canceled)
